(19) United States
(12) Patent Application Publication
(10) Pub. No.: US 2005/0080568 A1
(43) Pub. Date: Apr. 14, 2005

(54) Air traffic control system and representation of the earth's surface used therein

(76) Inventors: Stefan Enderle, Weissenhorn (DE); Alexander Wiechert, Pfaffenhofen (DE)

Correspondence Address: BARNES & THORNBURG, 11 SOUTH MERIDIAN, INDIANAPOLIS, IN, 46204, US

(21) Appl. No.: 10/766,444

(22) Filed: Jan. 28, 2004

(30) Foreign Application Priority Data
Feb. 28, 2003 (DE) 10308913.6

(51) Int. Cl. G06F 19/00

(52) U.S. Cl. 702/5

(57) ABSTRACT

The present invention pertains to a representation of at least one area of the earth's surface, whereby the area is divided into individual sections and at least two data are indicated for each of these sections, whereby the first datum (ELV) contains an elevation indication of the surface above a predetermined level, and the second datum (QTY) gives a measure of the accuracy and/or reliability of the first datum.

The present invention pertains to a representation of the earth's surface. Such representations of the earth's surface are required in particular for air traffic control systems and air traffic control methods in order to provide pilots and aircraft with the required information and terrain data for the terrain areas that are to be overflown.

Data sources that are available to the public or that can be purchased are already available for a majority of the earth's surface. They contain elevation data in various grids and with various vertical and horizontal accuracies. These data sources are often provided with an accuracy statement, which, however applies globally to the entire data source. A statement concerning the accuracy of the individual data points is not possible. This is to some extent necessary, however, since the average accuracies for certain terrain topographies do not possess very great significance. In a mountainous area, for example, it is critical that not only is average elevation data present, but that the peaks of the individual mountains are actually recorded accurately as well. Only in this way can aircraft be guided safely over mountains. Otherwise, when average elevation data is used or if the horizontal resolution of the elevation data is too great, it could happen that a peak is not resolved and is not transmitted to the aircraft.

The task of the present invention is therefore to make available a representation of the earth's surface or areas thereof that ensures the high reliability and accuracy needed for aviation. It is in addition the task of the present invention to make available a method for the creation of such a database for the representation of the area of the earth's surface by using otherwise available databases regarding topographical data, as well as applications for air traffic control methods and in air traffic control systems.

This task is carried out through the representation according to claim 1, the production process according to claim 35, the air traffic control method according to claim 55 and the device according to claim 56. Advantageous further developments of the methods and devices according to the invention are given in the respective dependent claims.

What is novel and crucial about the present representation according to the invention is the fact that the area of the earth's surface that is to be represented is divided into segments (cells) and that two data values are created for each of these sections, whereby the first datum is an elevation indication and the second datum is a measure of the accuracy and/or reliability of the elevation value. Thus, an individual measure of the accuracy and/or reliability of this single elevation value is given for each individual data value. The accuracy and reliability of the elevation data can therefore by indicated in very detailed fashion.

Optionally, either maximum elevation or average elevation can advantageously be used as elevation indications. By adding or subtracting a fixed value (offset), it is also possible to insert information concerning the nature of the terrain, e.g., fresh water, sea, land, etc., into the elevation indications.

The earth's surface to be represented is advantageously divided into individual segments, the boundaries of which advantageously run parallel to degrees of latitude and longitude. An elevation indication and a reliability value are created for each such segment. The values for the individual segments are summarized segment by segment, and several segments are thus stored jointly in one file. In this regard, it is advantageous to use separate files for the elevation indications and the reliability indications. It is advantageous for additional information files to be attached, in which it is recorded if elevation data is present for a certain segment, if only indications regarding a sea's surface are present in the given segment, or if no segment file is present for the given segment, since no elevation data is present. In such a case it can already be seen from this information file whether relevant data are present or available.

To create the representation according to the invention, files are used that are commonly available or that can be purchased. Such files are sufficiently available for most area's of the earth's surface, and contain more or less assured and reliable elevation indications with the widest variety of resolutions. Often, global indications also exist for the individual files with regard to the reliability of the elevation indications contained in them. These reliability statements are global for each individual file, i.e., they are uniform for all of the elevation data contained therein.

With the present invention, for the first time it has now been possible to evaluate and merge these various data sources, and to convert them into a format that satisfies the high safety standards of the civil aviation industry. To do this, one or more of the following steps can be carried out for each individual data source whose material finally goes into the representation that is to be created:

The data from the data sources is converted into a specific, uniform data format, and for each individual elevation datum a second value is created, which represents the deviation of the elevation datum from the actual elevation, or an error value regarding the elevation datum. As a result of this importation step, the data sources are, first, made uniform, and second, each individual elevation value is provided with its own error criterion. In a further step, these data are then brought to a common standard with regard to the horizontal and/or vertical resolution. The data that have been revised in this way are then further converted to a predetermined horizontal resolution. This predetermined horizontal resolution can be variously chosen, depending on the requirements for the particular representation of the data area. It can also differ within an individual representation; for example, it is possible usually to indicate the elevation data with a resolution of 30 seconds of an angle in terms of latitude and longitude, but to increase the resolution to 15 seconds of an angle in the vicinity of airports.

These elevation data are then checked for their credibility. First, the second values pertaining to the deviations or the error values of the elevation indications come in here, as does the information concerning the individual data sources. The second data are optionally modified.

If the representation is not to contain average elevation values, but rather maximum elevation values, as is often advisable for safety reasons in the aviation industry, a maximum elevation can be determined for the individual values.

Subsequent to this revision of the elevation values, which is carried out separately for each individual data source, the elevation data from the individual data sources are merged in total and from them an elevation datum and a second datum pertaining to the accuracy and/or reliability of the elevation value are created for each segment.

Finally, the data that have been created in this way are optionally converted into a predetermined data format that can be read by the appropriate systems in aircraft.

All of the intermediate steps are advantageously recorded in so-called log files. The total process that has been carried out can also advantageously be recorded in a process control file. This makes it possible to prescribe as well as plan in advance and reconstruct each individual step in the creation of the representation of the earth, and thus ensure extremely high reliability and reproducibility. This is especially necessary in the aviation industry in order to obtain approval of the representation according to the invention and the method according to the invention for use in civil or military aviation.

In the following, the method according to the invention will now be explained in more detail through the use of a concrete example.

The following are shown:

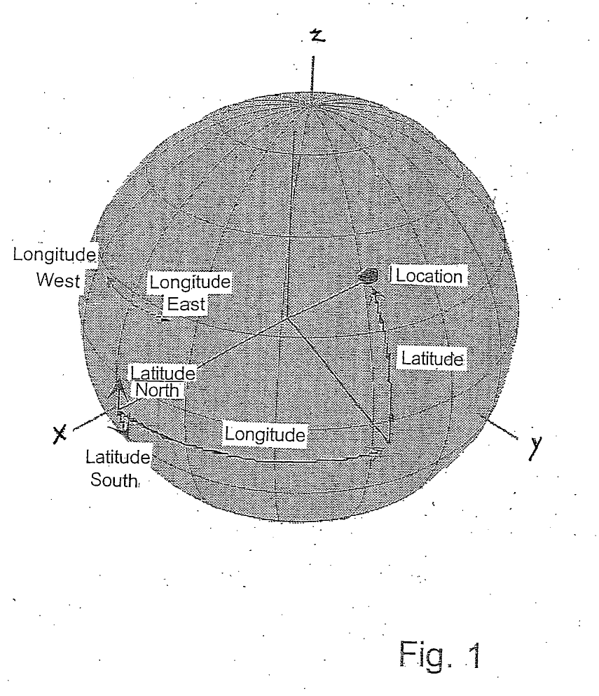

FIG. 1 the WGS-84 ellipsoid;

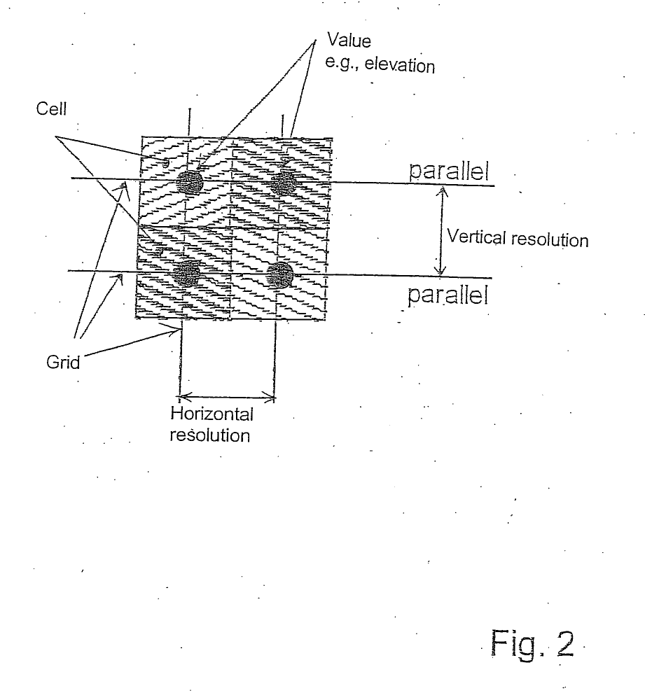

FIG. 2 the orientation of individual segments (cells);

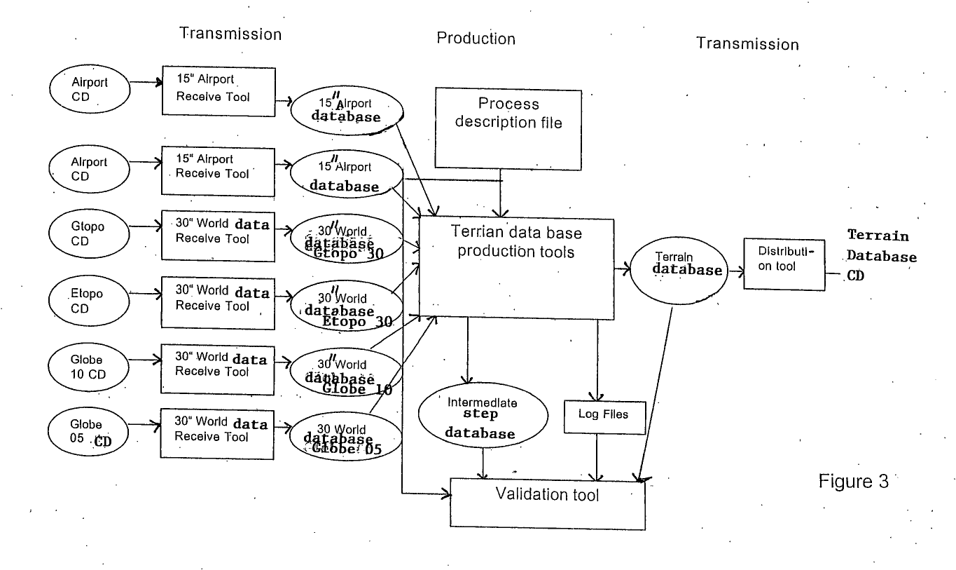

FIG. 3 an overview of the method according to the invention;

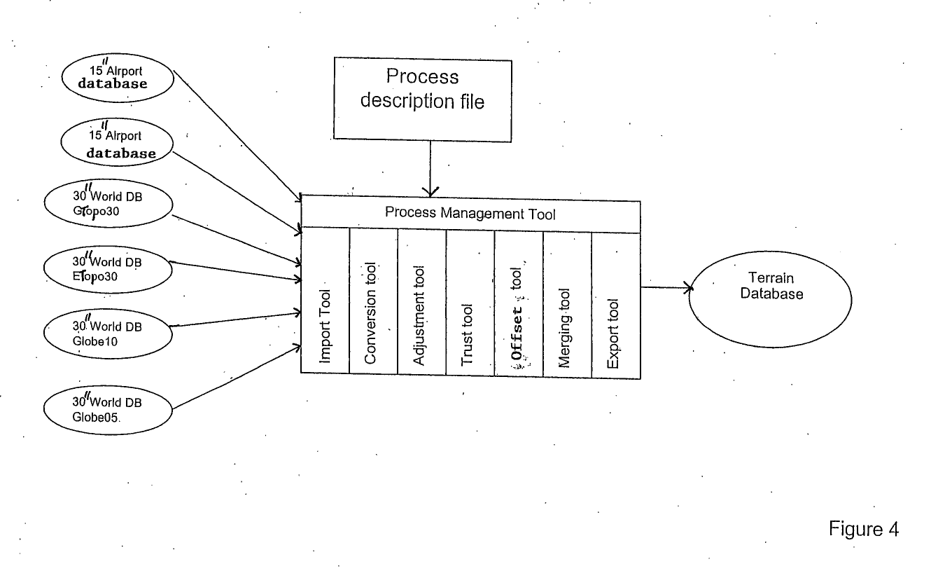

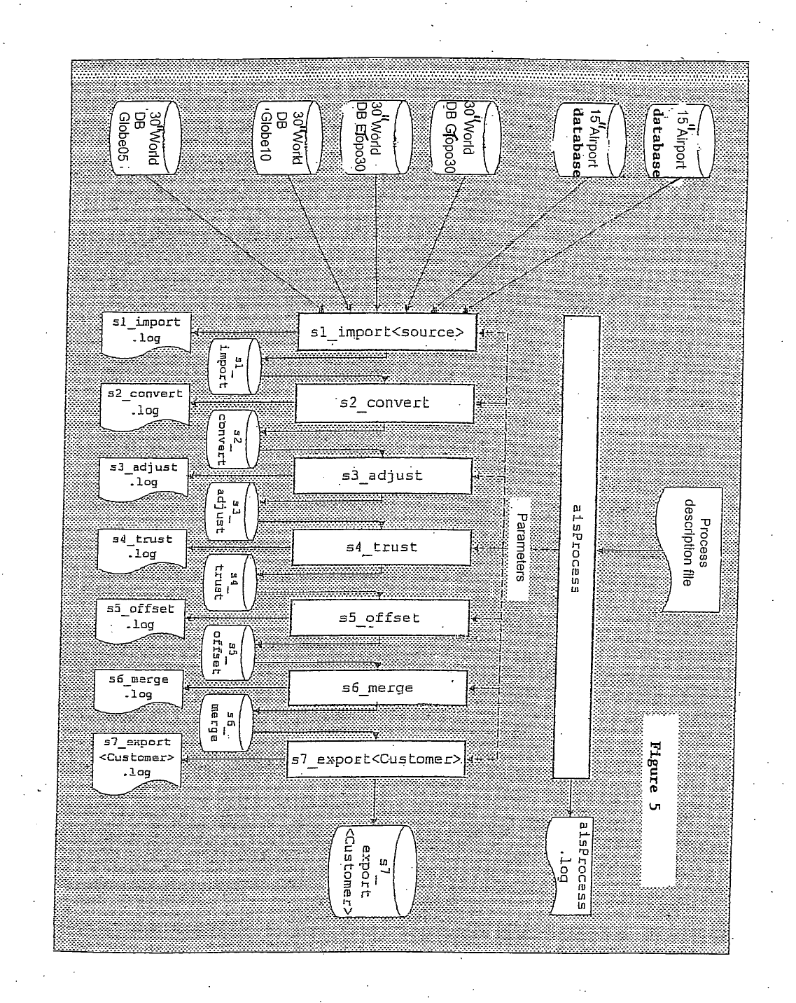

FIG. 4 an additional, more detailed overview of the method according to the invention;

FIG. 5 the process flow of the method according to the invention;

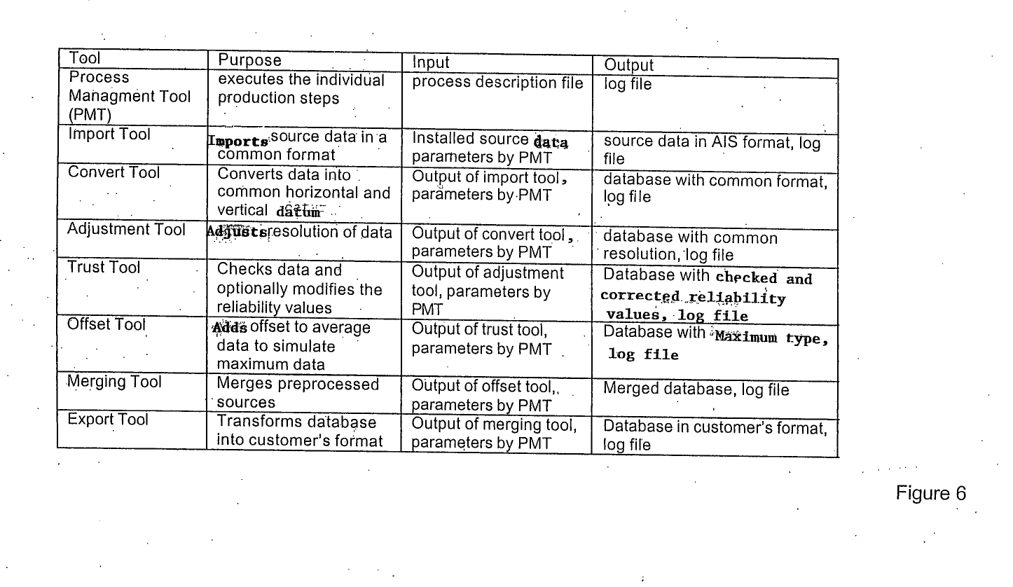

FIG. 6 an overview of the individual steps of the method;

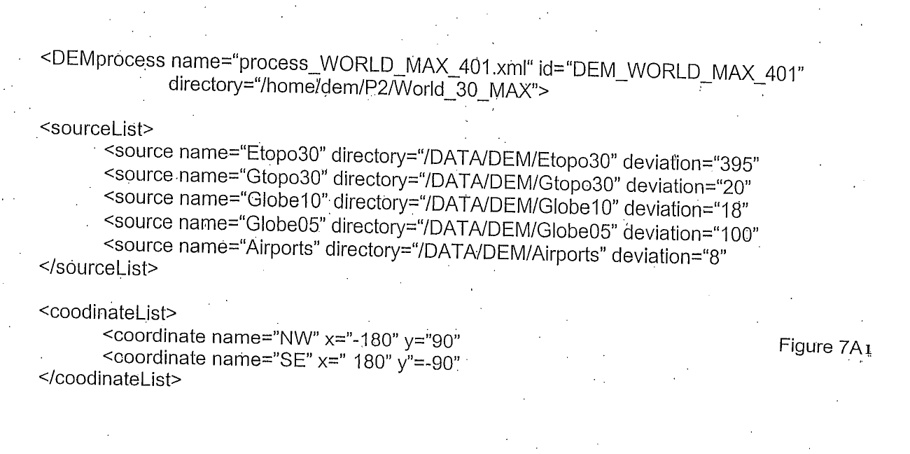

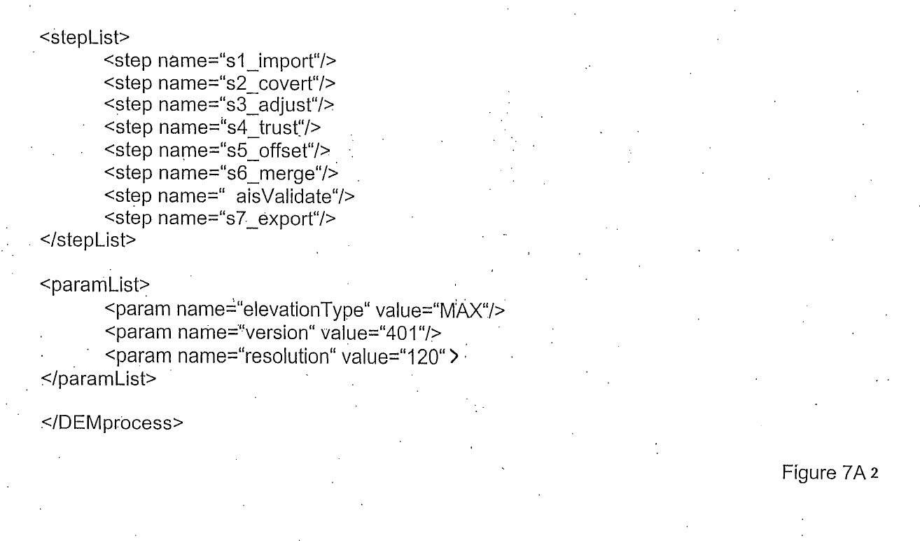

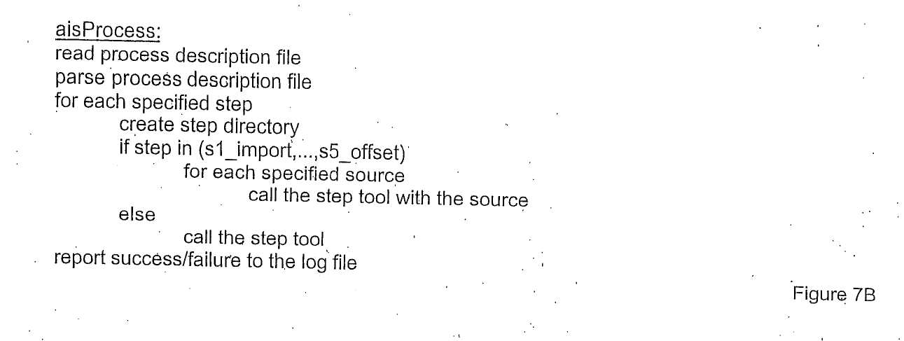

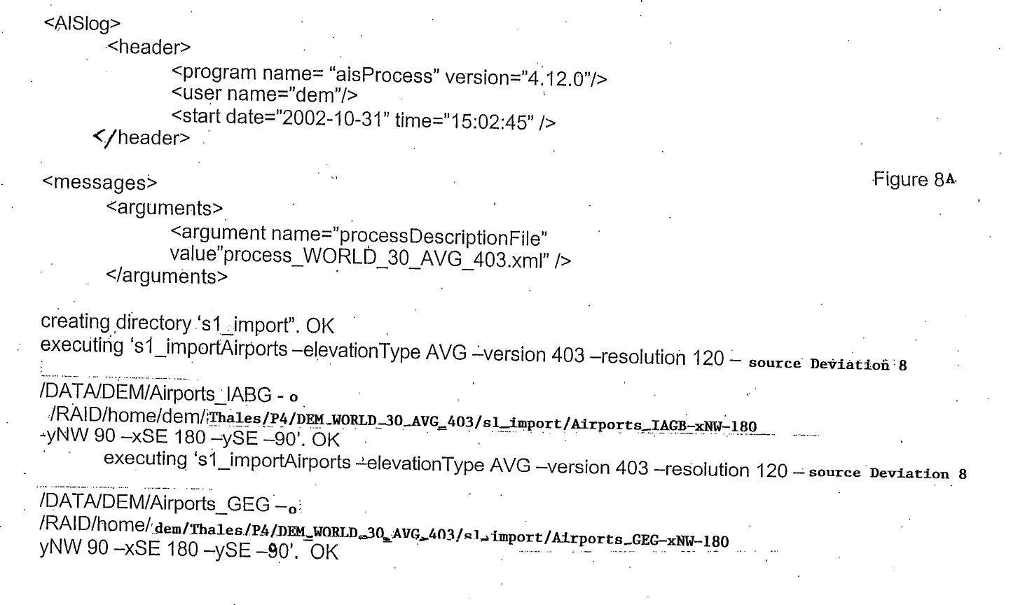

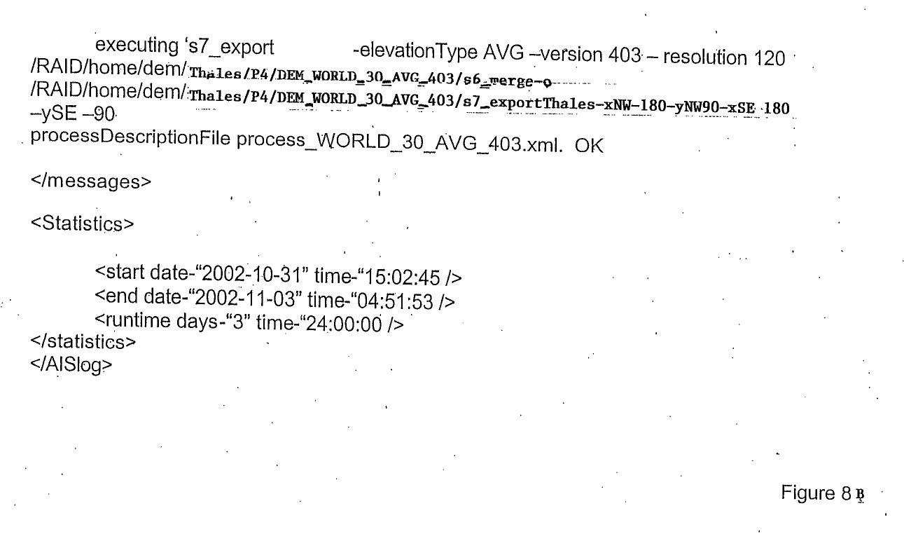

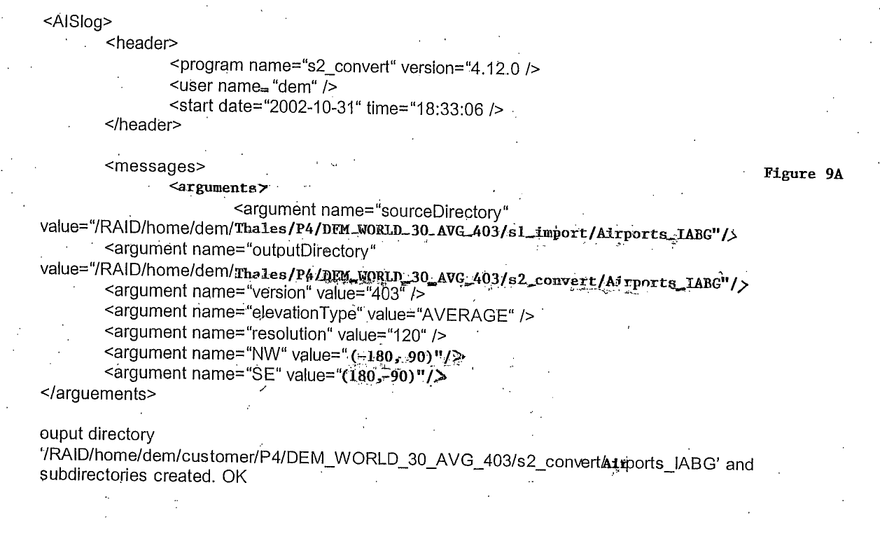

FIG. 7A a process description file;

FIG. 7b an algorithm of a process management tool;

FIG. 8 a log file of the process control of the method according to the invention;

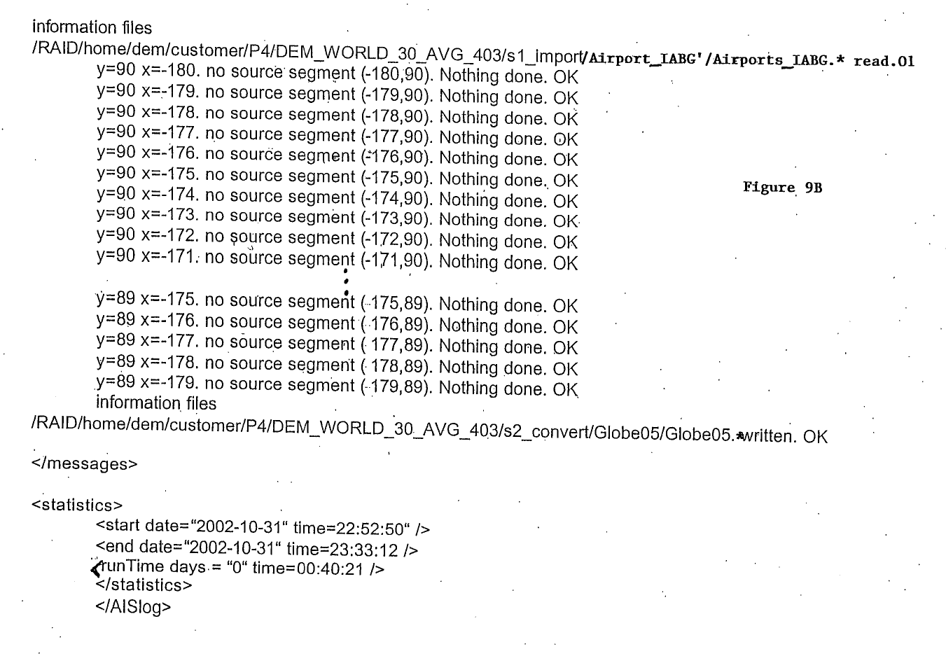

FIG. 9 a log file of the conversion step;

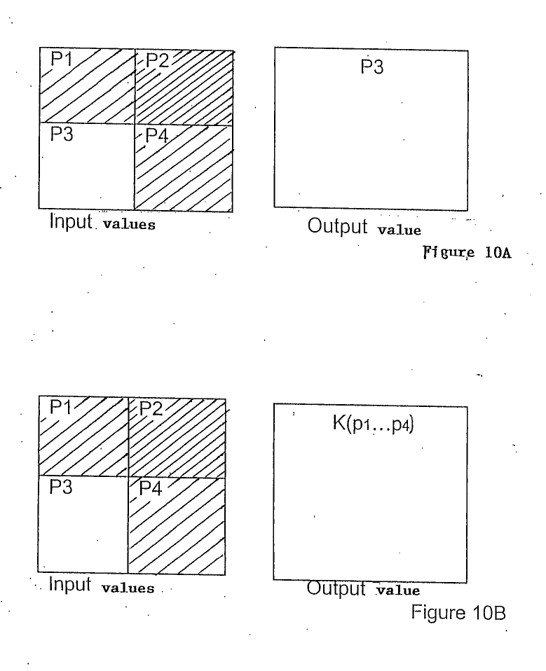

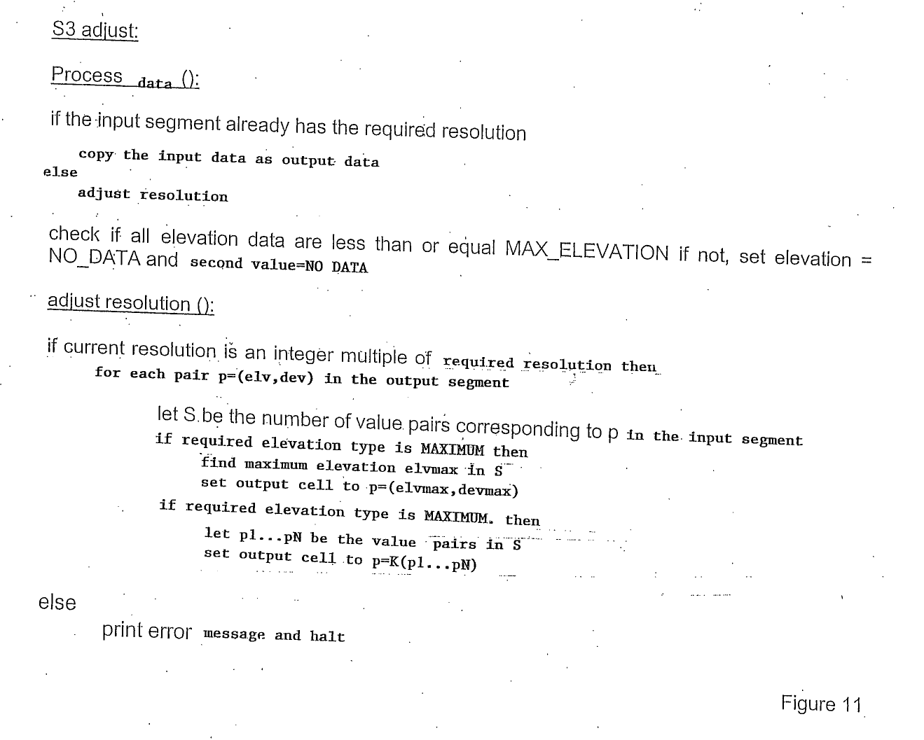

FIG. 10 in subfigures 10A and 10B, the determination of an elevation value from the data of a data source with high resolution;

FIG. 11 a program excerpt of adjustment step s3;

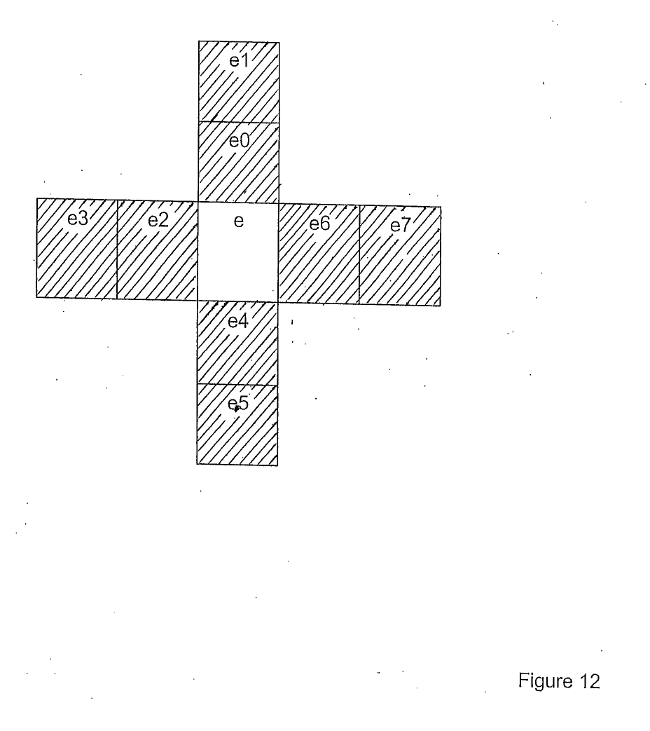

FIG. 12 the determination of neighboring elevation values for checking the credibility of the data from a data source;

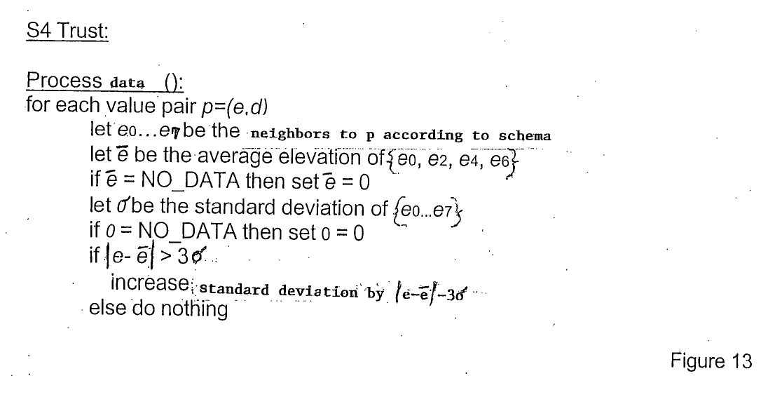

FIG. 13 a program excerpt from the checking step;

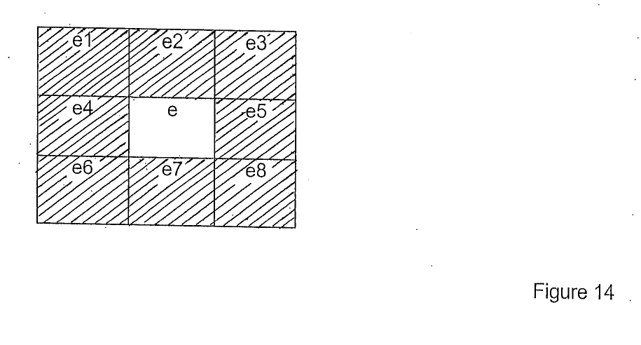

FIG. 14 the determination of a maximum elevation value;

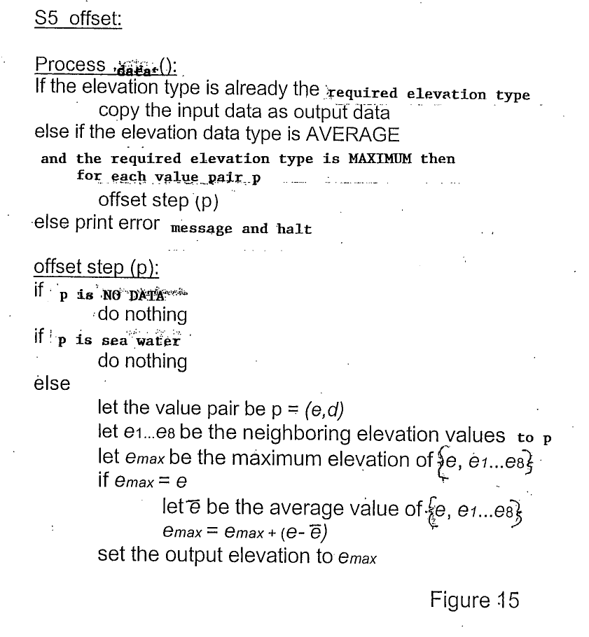

FIG. 15 a program excerpt from the step for determining a maximum elevation value;

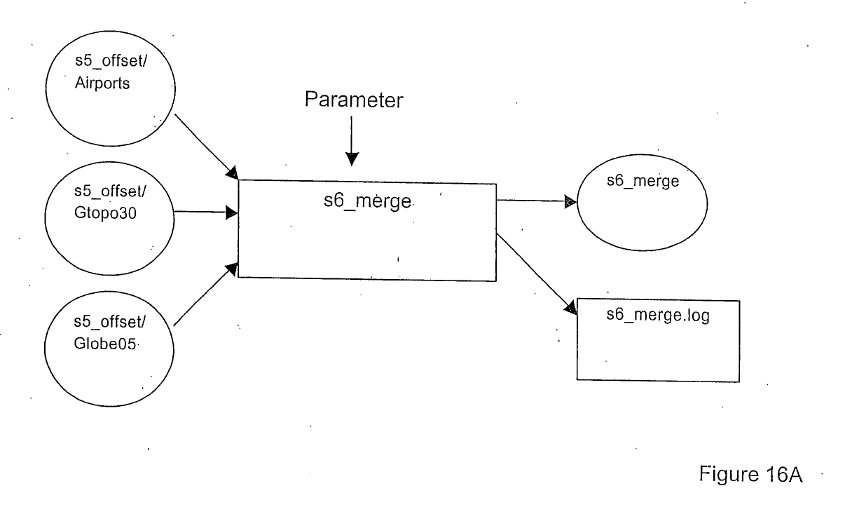

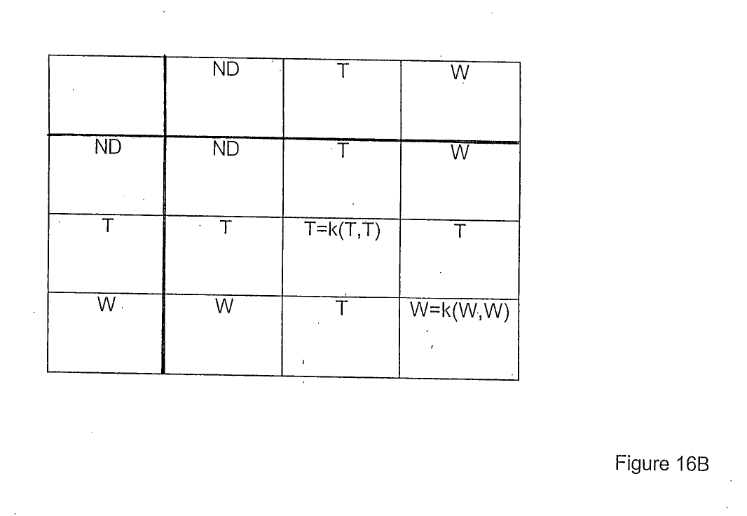

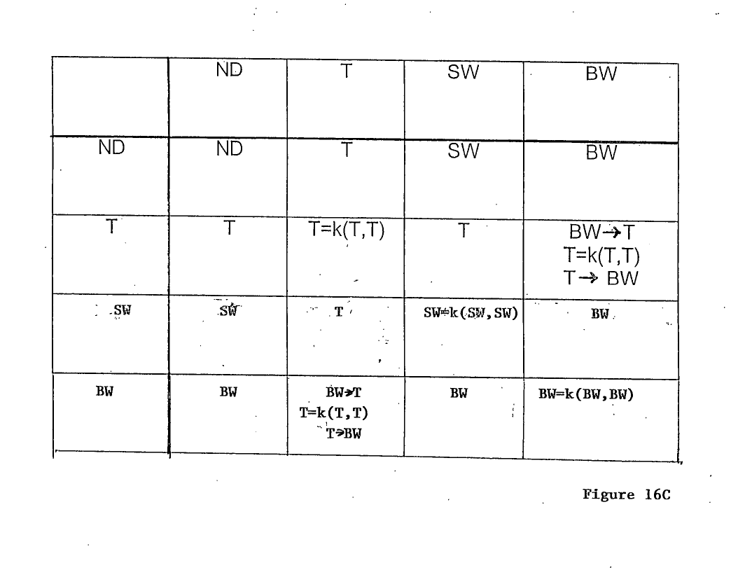

FIG. 16A the functionality of the merge step;

FIGS. 16B and 16C the logic tables for determining an elevation value from various data sources with no data (NO DATA, ND), terrain data (Terrain Data, T), as well as water in general (Water, W), sea surfaces (Sea Water, SW) and body of water surface (Body of Water, BW);

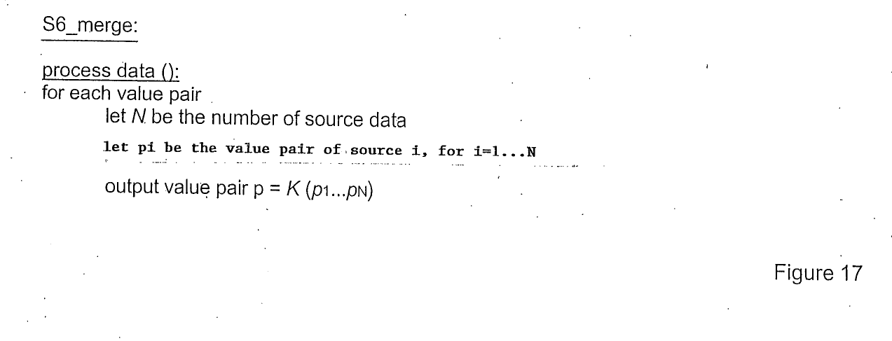

FIG. 17 a program excerpt from the merge step;

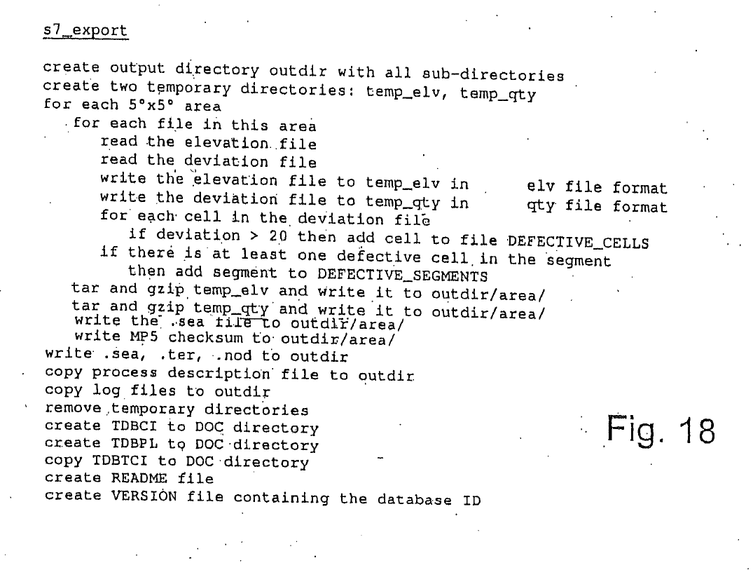

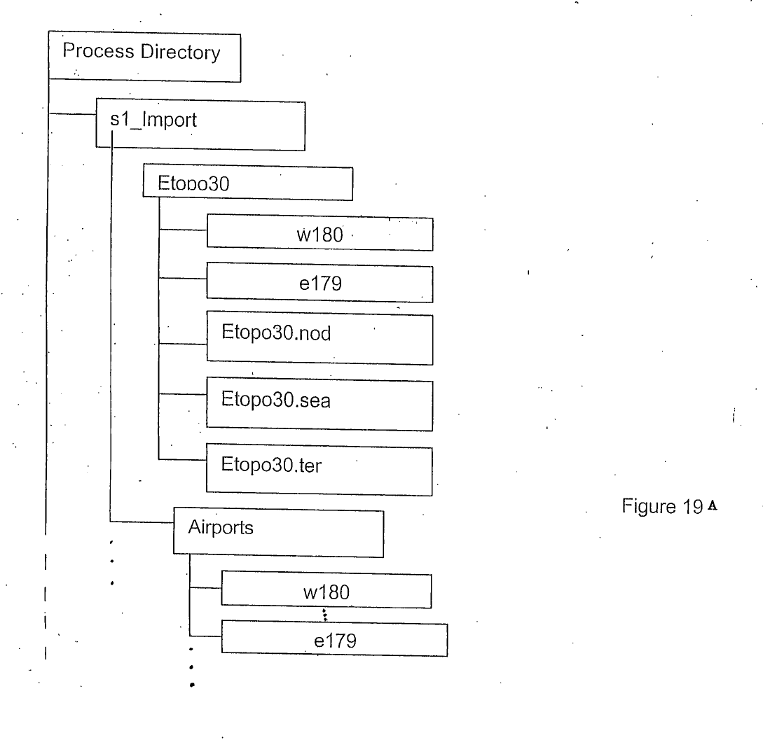

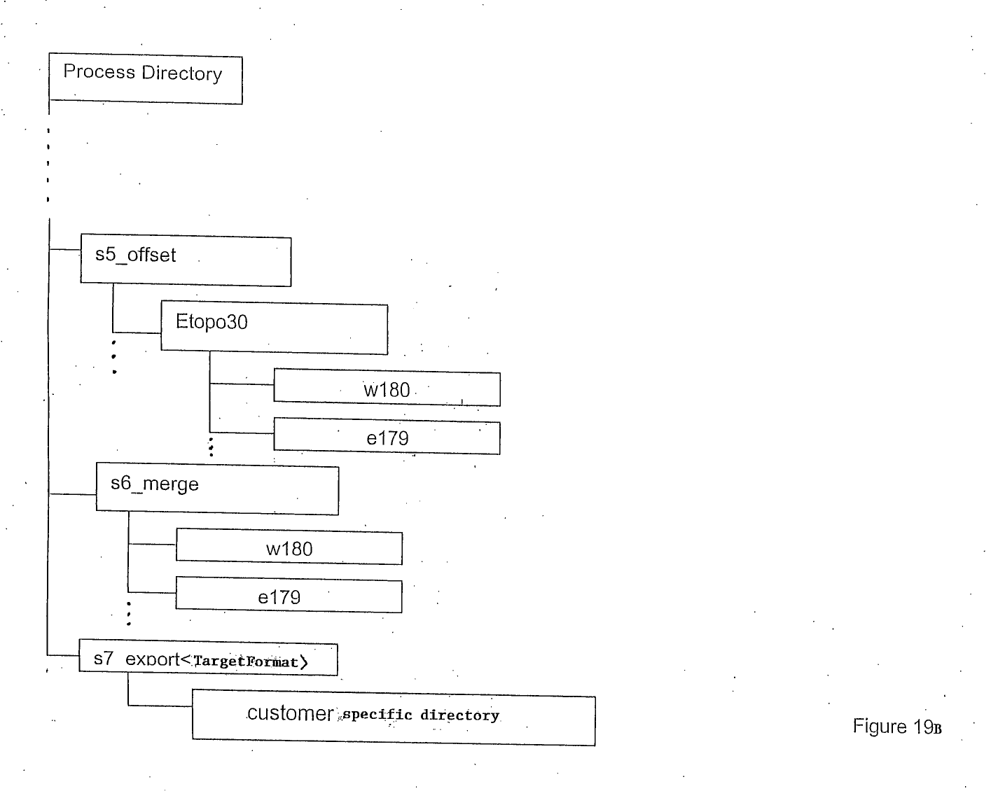

FIG. 18 a program excerpt from the export step;

FIG. 19 the directory structure of a representation according to the invention on the production system;

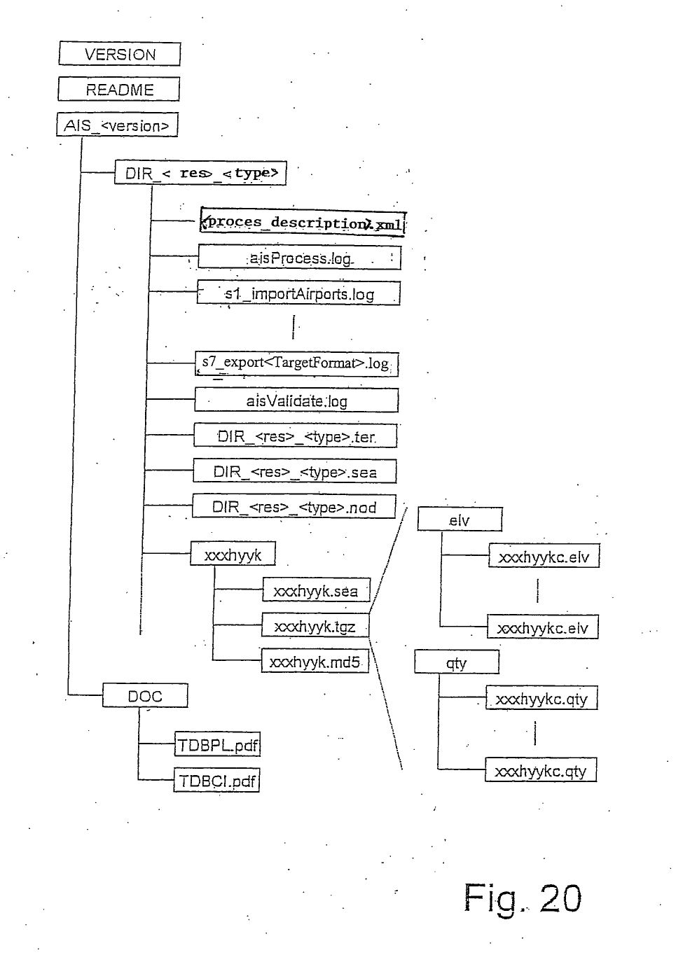

FIG. 20 the directory and file structure of a representation according to the invention on the data carrier;

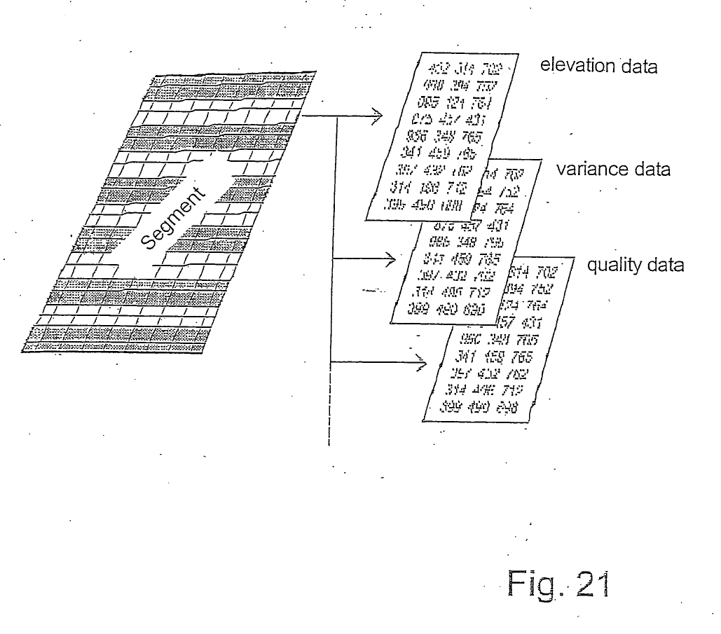

FIG. 21 the file structure of the elevations, reliability and variance data of the sections of a segment;

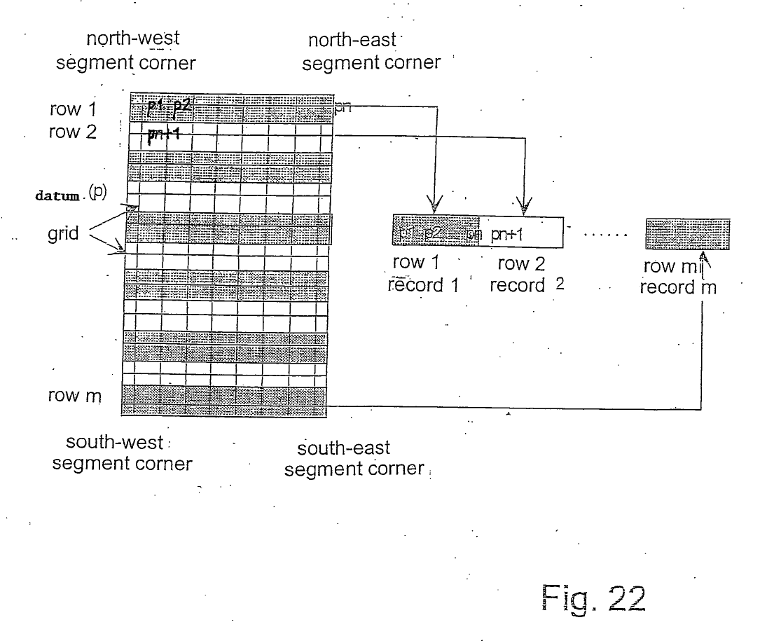

FIG. 22 the structure of a data file;

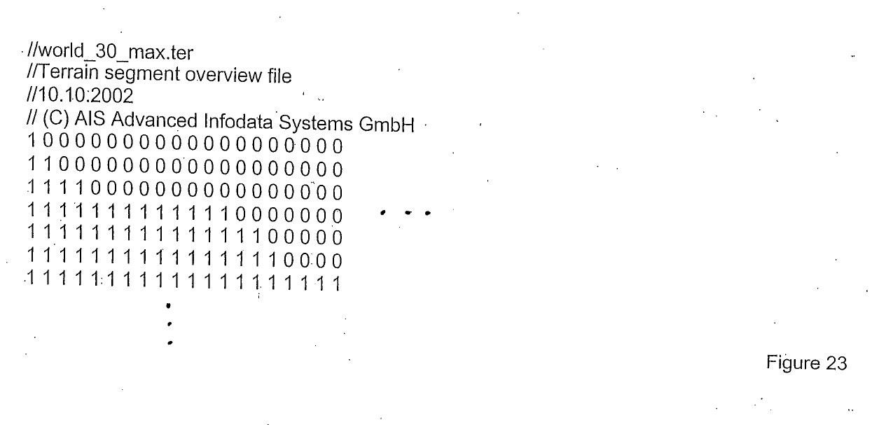

FIG. 23 the structure of an information file;

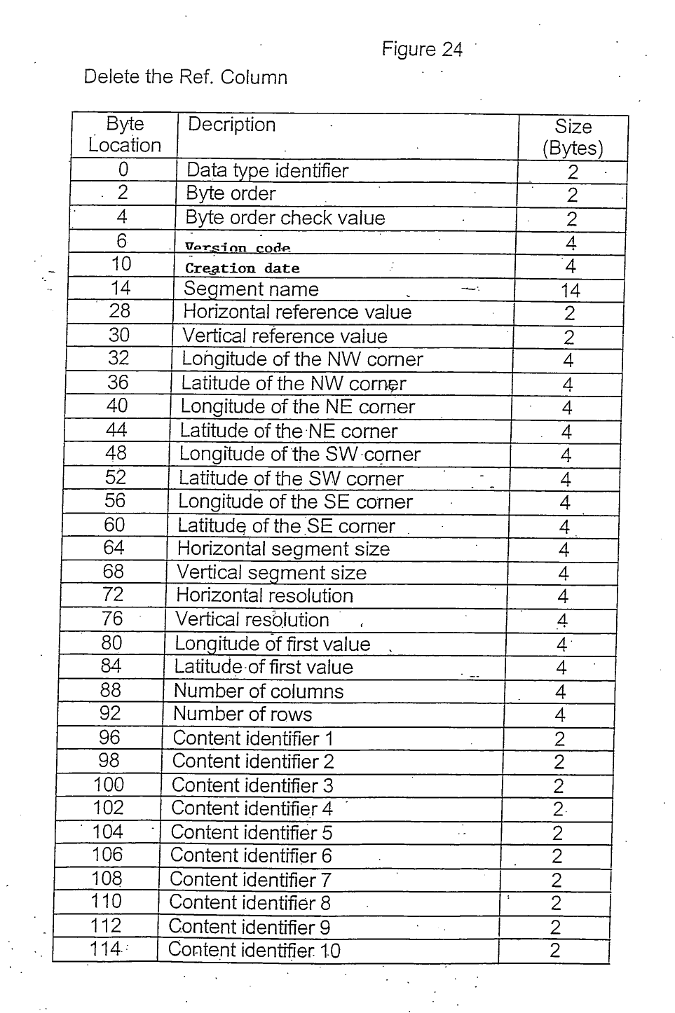

FIG. 24 the header area of a segment file;

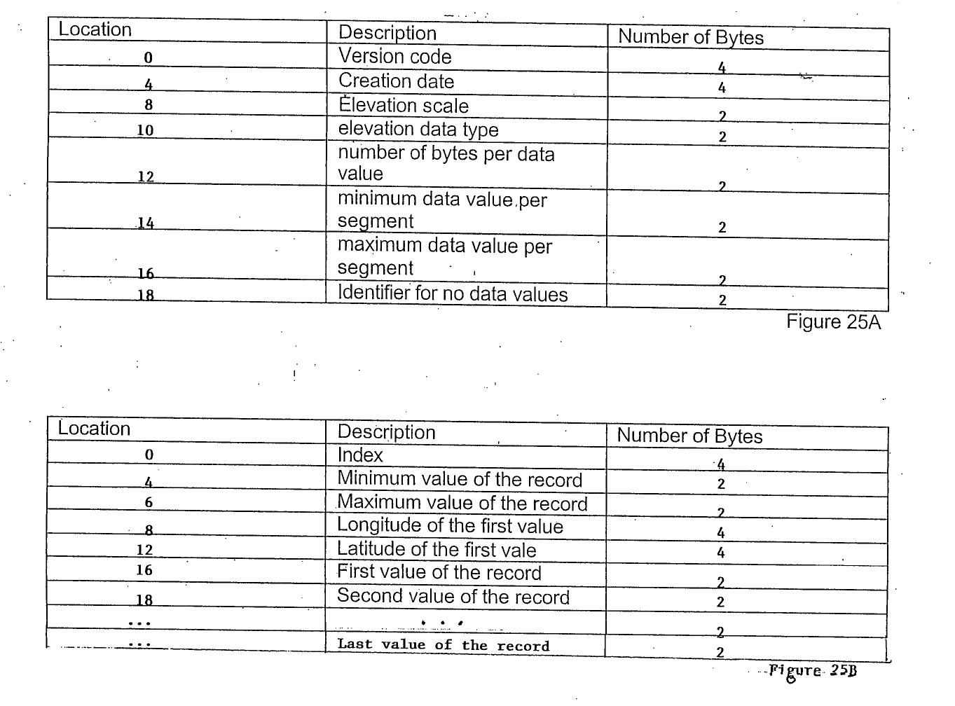

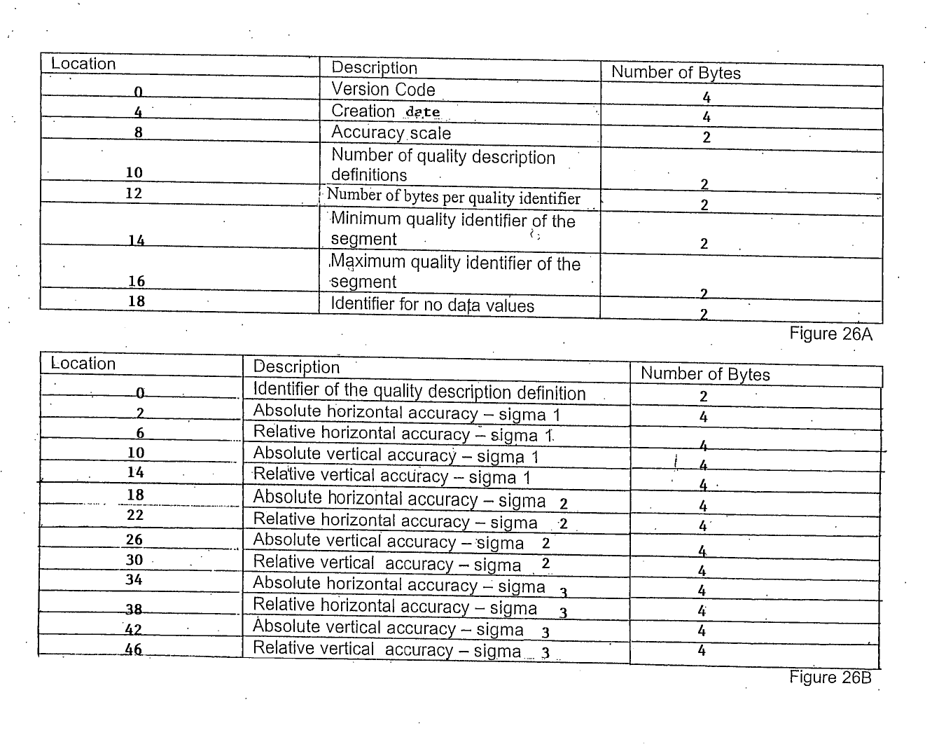

FIG. 25 the header area and the data area of an elevation data file;

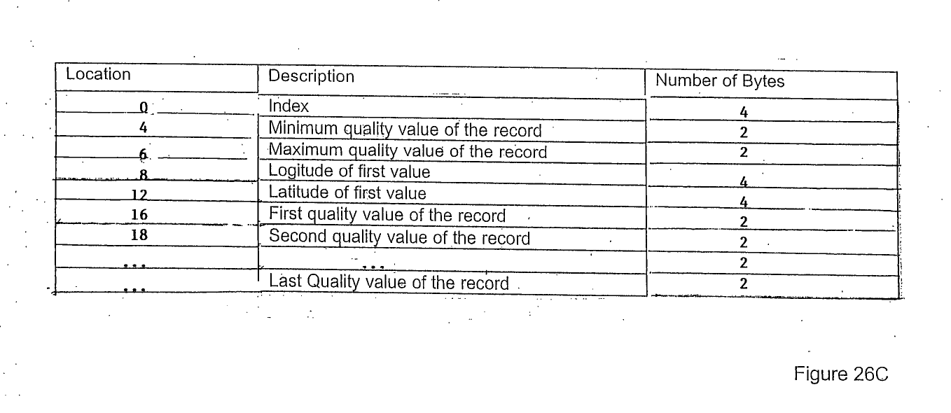

FIG. 26 the header area, the definition area, the identification area of a quality file;

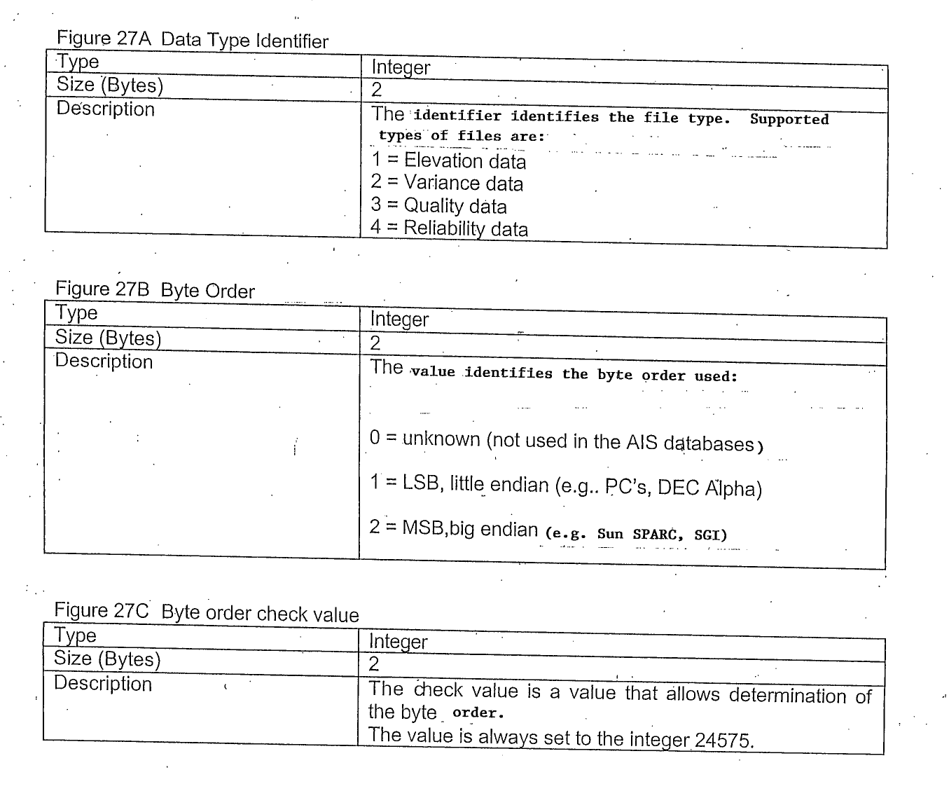

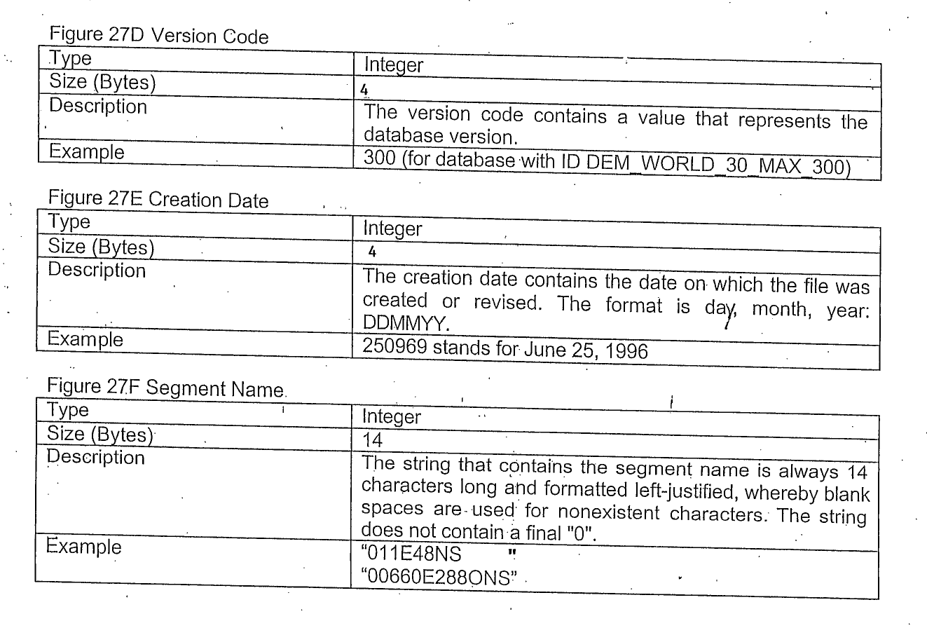

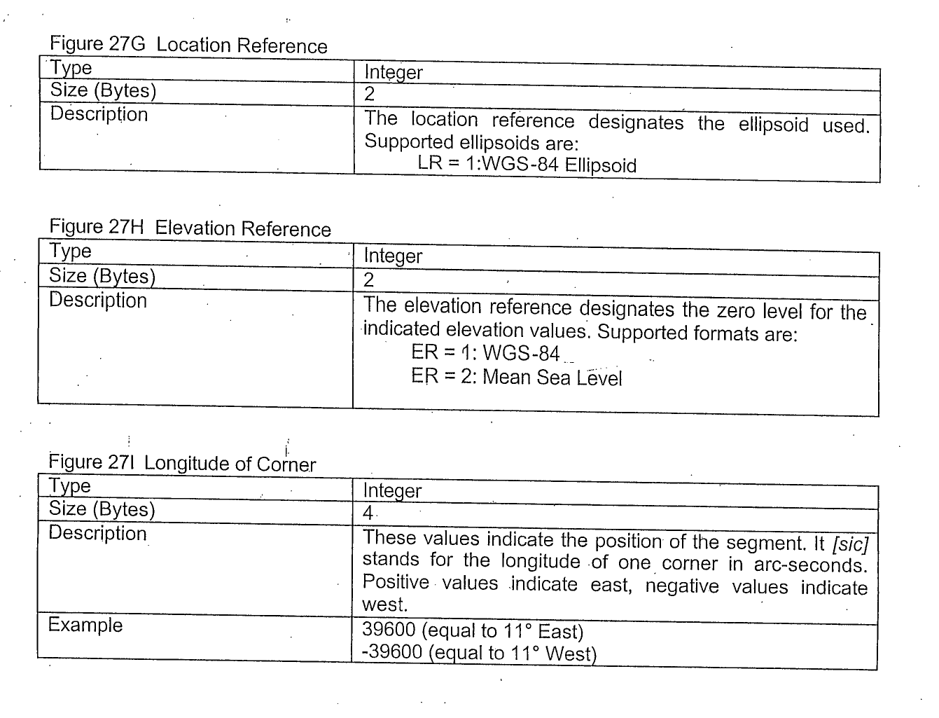

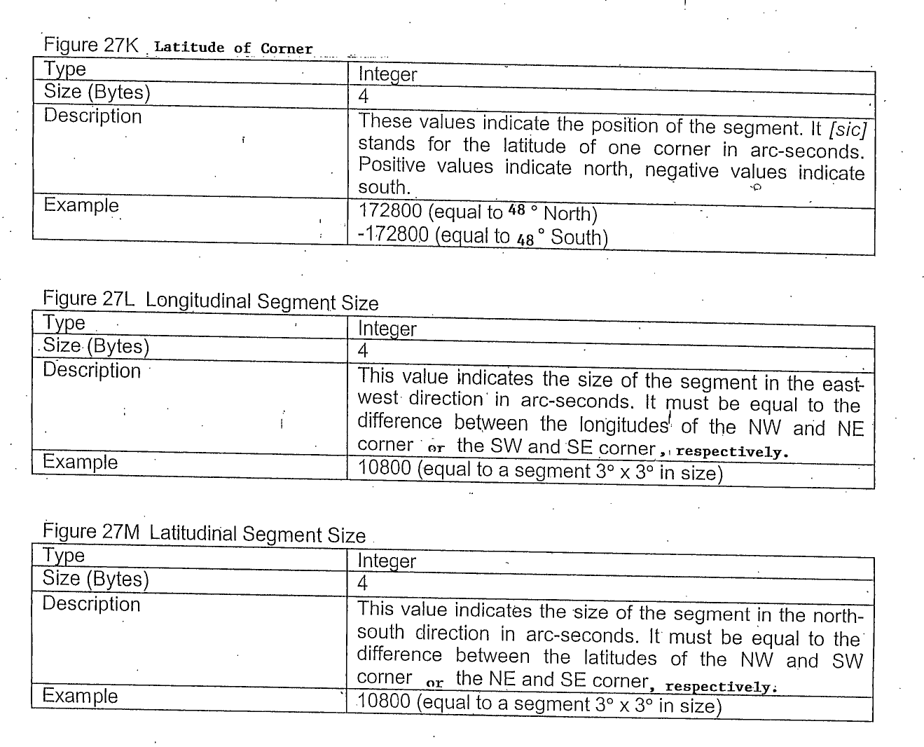

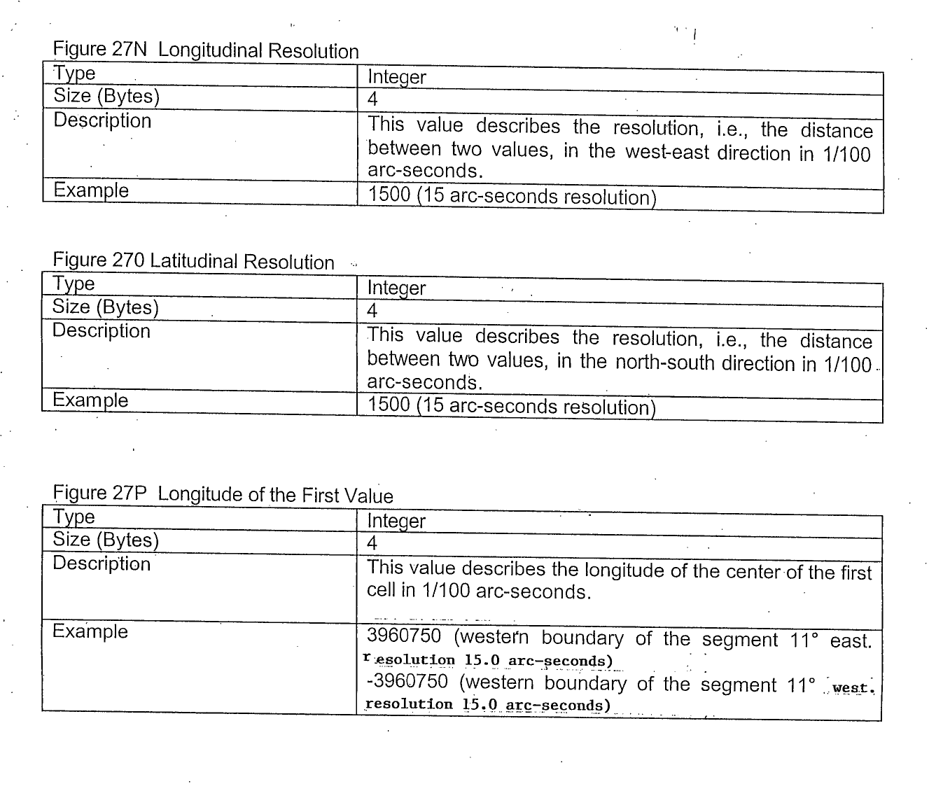

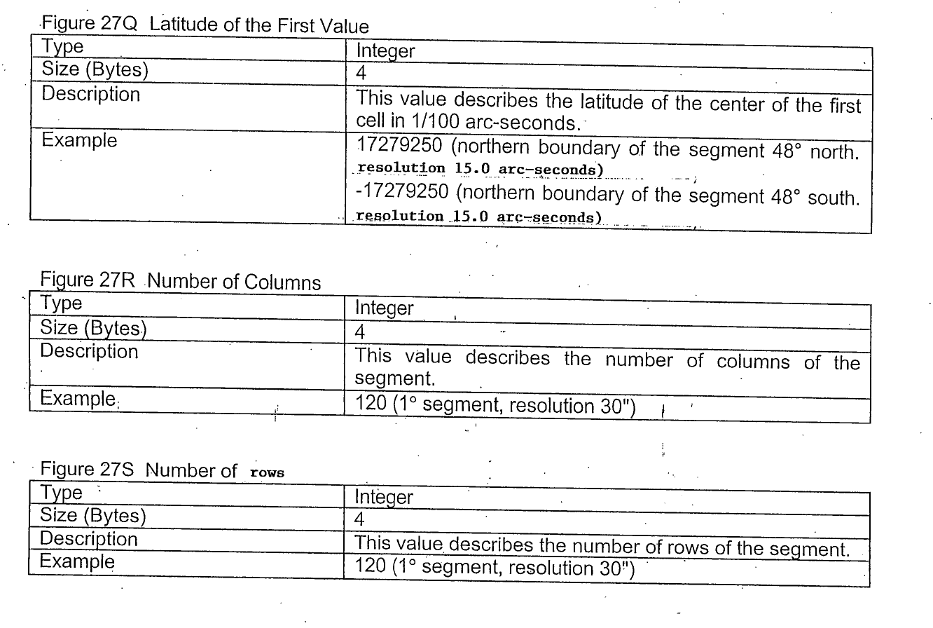

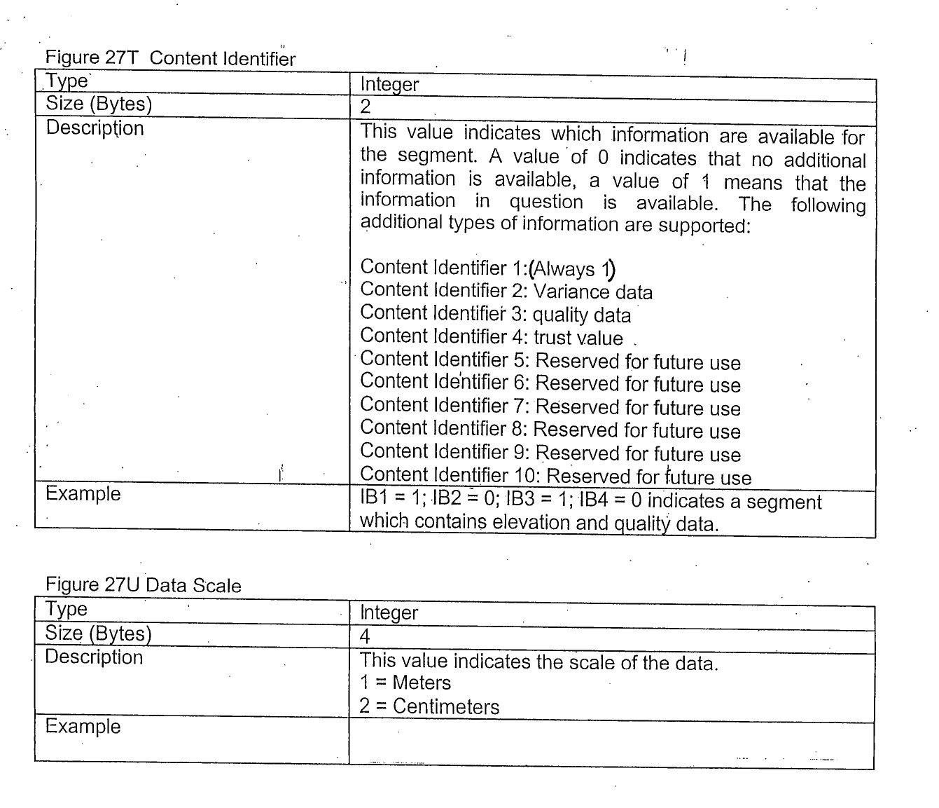

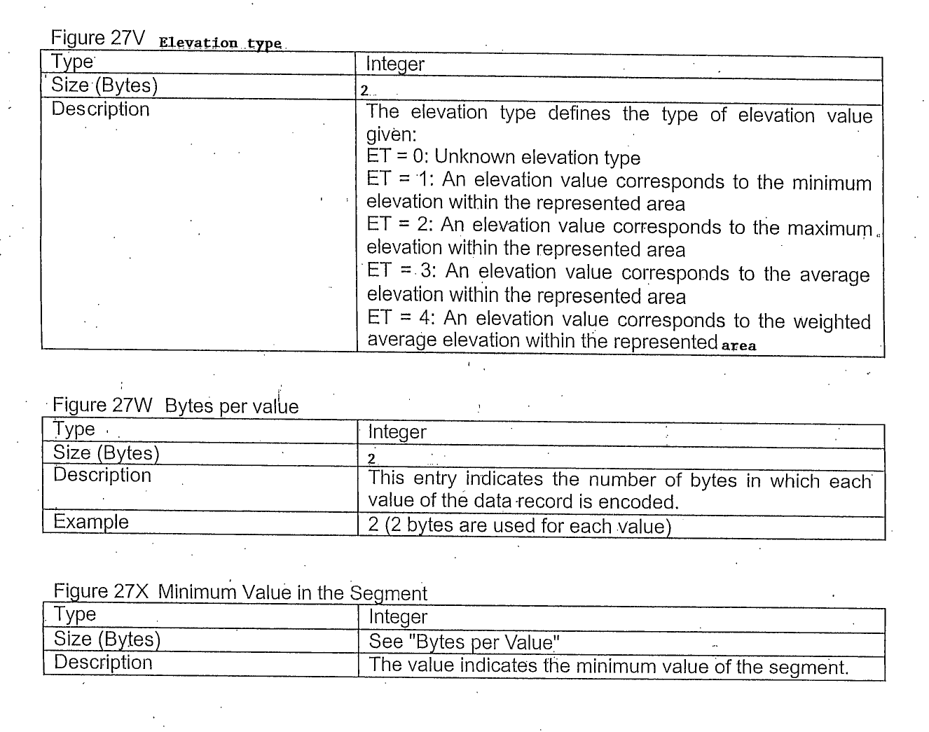

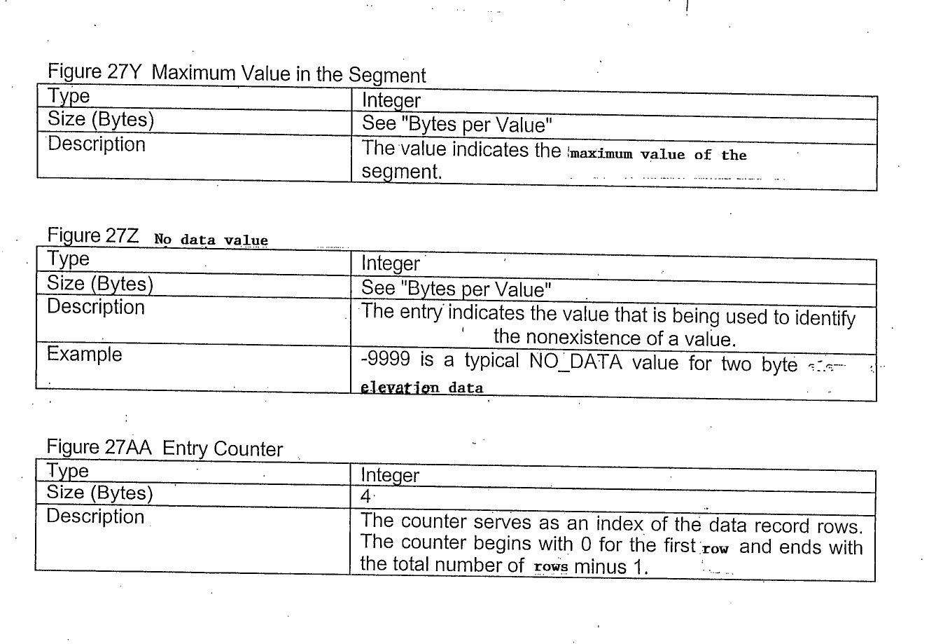

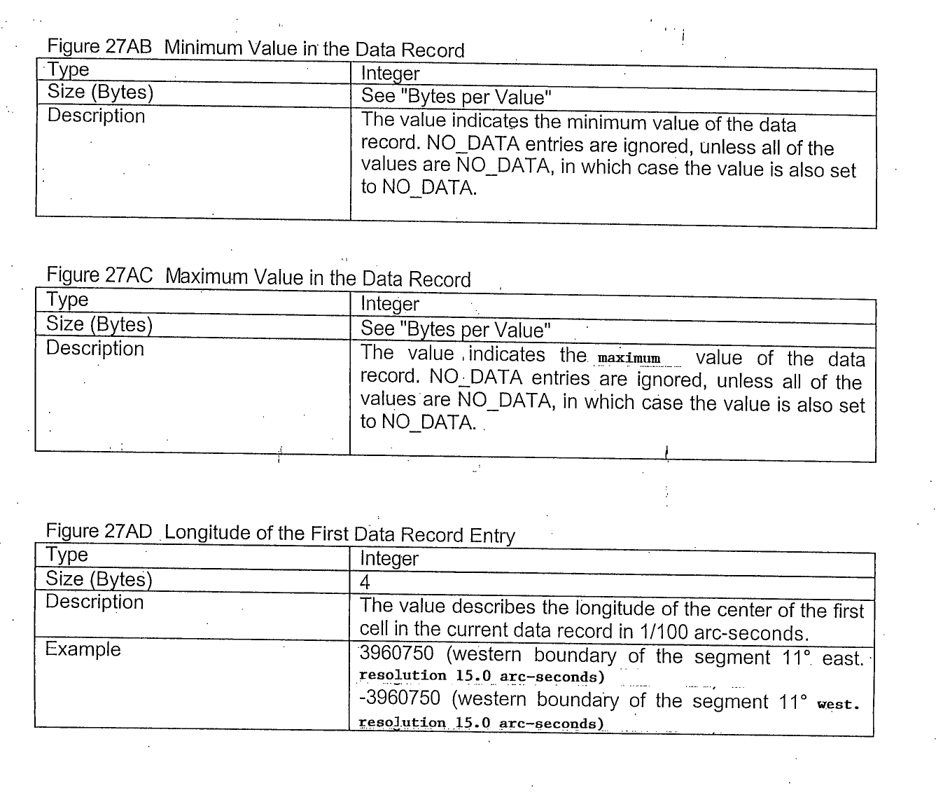

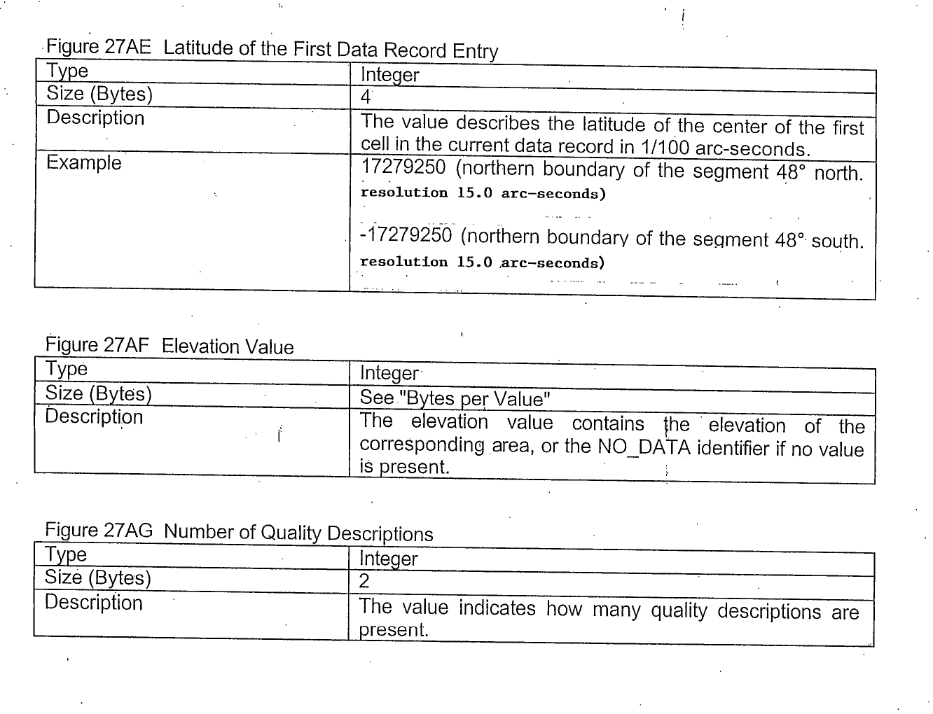

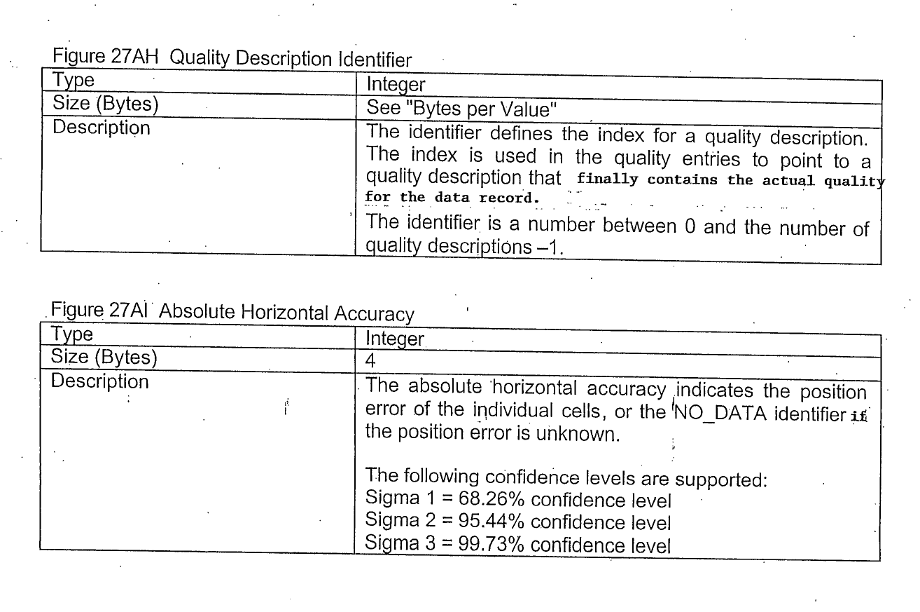

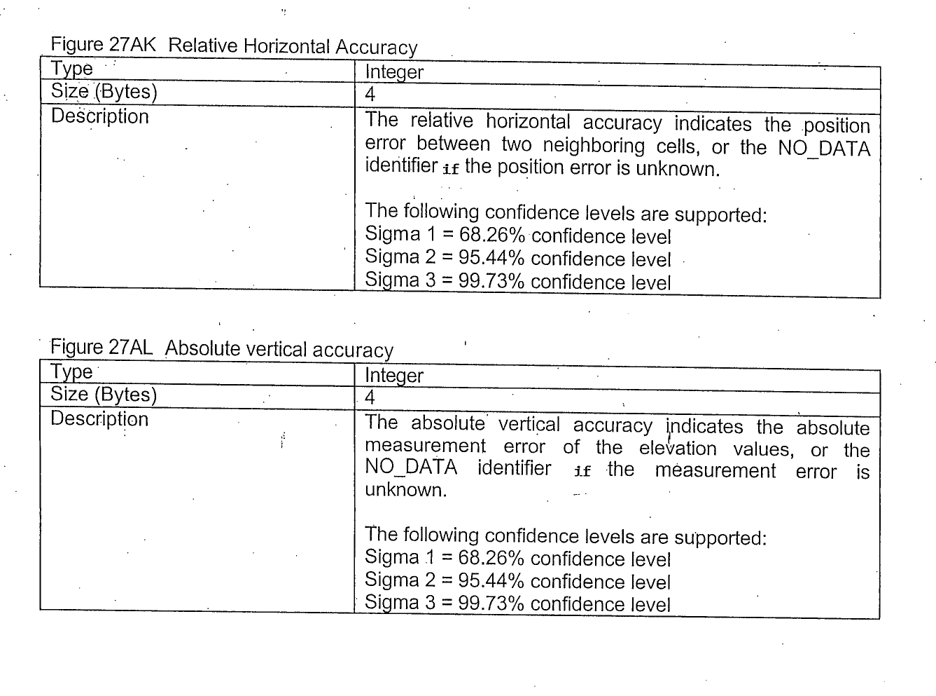

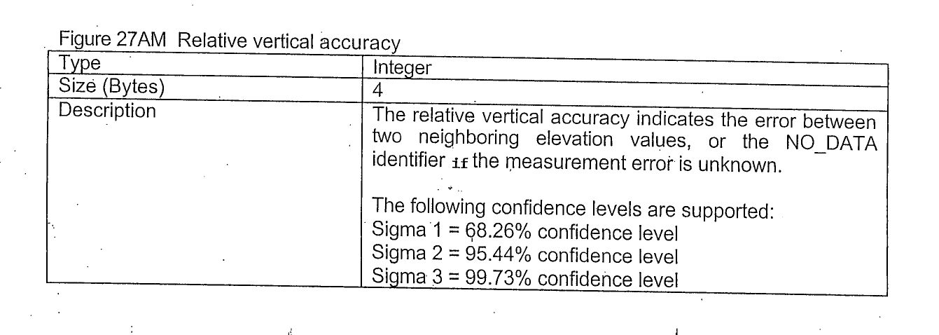

FIG. 27 in the subfigures A through AM, an explanation of the individual elements from FIGS. 25 and 26.

The following example represents a grid-based digital elevation model that represents the entire world with a 30″ resolution, and with a 15″ resolution in selected areas. Each grid cell (section) represents a nearly rectangular area of the earth's surface 30 angle seconds by 30 angle seconds or 15 angle seconds by 15 angle seconds, and contains specific data regarding this section. Included in these data are the following:
Maximum elevation (ELV), which represents the maximum elevation within the particular section of the earth's surface, and
a quality value (QTY) containing information about the vertical and horizontal accuracy of the elevation datum in the given section.

In this example, the longitude and latitude positions are geographically referenced to the WGS-84 ellipsoid shown in FIG. 1. The individual cells are shown in a cell-centered format. Each value is placed centrally within the given cell. The value therefore represents an area that extends by half the longitudinal resolution in the east and west direction and by half the latitudinal resolution in the north and south direction from its position. This is illustrated in FIG. 2.

The elevation data (ELV) are shown referenced to mean sea level (MSL).

FIG. 3 shows an overview of the entire production process for the representation of the earth's surface according to the invention. The large square in the center represents the basic production processes, which include a total of seven individual process steps. These individual process steps are explained further below. As can be seen, data from the individual data carriers (e.g., compact discs or DVDs), which contain, for example, elevation data with a resolution of 1-15 angle seconds for airports or 30 angle seconds for other areas of the earth's surface, are imported and then processed.

Shown in FIG. 4 is a detail from FIG. 3 in which only the seven central production steps are shown. The production process can be broken down into a total of seven tools:
1. The process management tool executes the individual production steps;
2. The import tool converts the individual data sources into a common format;
3. The data conversion tool converts the source data into a common horizontal and vertical datum;
4. The adjustment tool adjusts the resolution of the data to the desired target resolution;
5. The trust tool optionally changes the reliability values for all cells (sections);
6. The offset tool calculates an artificial offset in order to simulate maximum data;
7. The merge tool merges the individual preprocessed data sources, and
8. The export tool exports the created database and converts it into a format that is, for example, requested by a customer, such as, for example, an airline company or an aircraft manufacturer.

The entire process as just described in overview is codified in a process description file and can thus be customized. This process description file is an XML file that specifies the original data sources to be used, the process steps to be executed, and several parameters such as, for example, the DEM resolution, the database version that is being used, etc. This process description file will be described in more detail below. It serves as an input medium for the process management tool, which executes the other tools or steps in accordance with the content of the process description file. In principle, the following sequence of steps is maintained, whereby, however, the sequence can optionally be varied as well.

1. Import Tool

This tool imports the individual source data in their own data format and saves them in a predetermined format. This step is dependent on the format of the source data, so a different execution takes place for each individual data source. The actual conversion of the data can take place using conventional methods.

2. Data Conversion

In this step, the data are converted to the WGS-84 ellipsoid in the horizontal direction and to mean sea level in the vertical direction. Of course, this step is unnecessary in the case of source data that are already available in this system, otherwise this conversion has to be done individually for each data source.

3. Adjustment

This tool converts all of the data to a desired horizontal resolution.

This can be 15 angle seconds or 30 angle seconds, for example. This step must also be performed individually for each data source, or it can also be dispensed with.

4. Trust

This tool determines the individual values by evaluating the similarity of the elevation indications with reference to the neighboring values. Depending on this evaluation, the deviation for improbable values, for example, is increased. This step is also carried out separately for each individual data source, or can be dispensed with.

5. Offset

In this step, the maximum elevation values are determined through computation of an artificial offset value that is added to the average values if the data sources contain average values. The neighboring sections are taken into account when doing this. This step is also carried out separately for each individual data source.

6. Merge

This tool combines the data from the different sources, which has been processed as described above, into a single database.

7. Export

This tool exports the merged database in a specific file and directory format. The latter can be defined by a customer such as an airline company or aircraft manufacturer, for example. An exported database of this type as a representation of the earth is described further below.

All of the data are processed collectively only in the last two steps 6 and 7, while each individual data source is processed separately in steps 1 through 5. FIGS. 5 and 6 show steps 1 through 7 again, along with the process management tool with the particular output parameters (input) and the particular files created. As can be seen in FIG. 6, for each individual tool it is specified that a so-called log file is attached by means of which the executed step can be precisely reconstructed. In addition, the data created in each individual step are stored in a special file, and these data are then used for the next step. In this way, both the output data values and the created data values can be reconstructed in detail for each individual step and each individual tool.

In the following, the process management tool will be explained in more detail with references to FIGS. 7 through 9. This tool is used to ensure a reliable and consistent execution of all of the steps in the process, using all necessary steps with the correct parameters for each. This tool is in turn defined by the process description file, and executes the individual process steps.

The process description file is shown in FIG. 7 by way of example. In this case, it exists as an ASCII file in XML format, and has the following sections:
A header area with the name and the main process directory
A list of source data with the names of the sources and their directories
A coordinates list with the boundaries or the area to be represented
A steps list with the names of the steps to be executed for the source data
A parameters list with indications of the desired representation (e.g., type of elevation indication, resolution, etc., along with meta information such as version number, etc.).

In connection with this, the resolution, e.g., 30 angle seconds or 15 angle seconds for a resolution of 120×120 or 240×240 sections per segment respectively can be set as parameters, as can the type of elevation indication, e.g., maximum elevation or average elevation, and the version information that determines the database version to be used.

Like each of the other steps, the process management tool also creates a log file that records all of the steps executed by the process management tool. In addition, if all of the steps have been successfully executed, a report to that effect is written to the log file (in this case, ais Process.Log). An excerpt from such a log file is shown in FIG. 8.

In this example, process management tool version no. 4.12.0 has been started by a user named DEM. The process uses as its only argument the process description file process_WORLD_{—}30_AVG_{—}403.xml. First, it creates the directory s1_import, and then executes step s1_import for each individual data source. These sources are located in the corresponding directories, also listed in FIG. 8, with the ending /s1_import/Etopo30, etc. The rest of the steps that were executed are not mentioned in the excerpt in FIG. 8. Only the end with execution of step s7_export is mentioned again.

An excerpt from the corresponding log file for the conversion step s2-convert is found in FIG. 9. The log files of all of the process steps from the import step to the export step all have the same structure. In these steps, one segment is read, a defined computation is performed on this segment, and the result is then written to a different directory as a new segment. This is carried out for all of the segments of a database in succession. This is recorded in detail in FIG. 9.

Once again, the tool name, its version, etc., is written to the log file. In a second part of the log file, a line that presents the various details of the processing is recorded for each of the segments that was considered:

The coordinates of the segment, the existence of a segment (“no source segments” or “source segment read”), the successful check of the preconditions, the basic step (“segment converted” or “source segment empty”), and the readout of the computation results as a new segment file (“output segments written” or “nothing written”). Here as well, an an indicator is then inserted to indicate the successful execution of this tool or process step (“OK”). This indicator ends that particular line and shows that the given segment was read, processed, and the processed data stored successfully.

Overall, each of the individual tools from the import tool to the export tool is conceptually built from exactly the same steps:
1. Check of the predefined parameters.
2. Reading of a segment
3. Check of various predefined conditions
4. Processing of the segment data
5. Readout and storing of the processed data segment by segment.

The following algorithm can thus be established for all of the steps:
Check parameters ( )
for each segment
   Read source file ( )
   If no file exists, continue process with next segment
   Check preconditions ( )
   Process data ( )
   Write processed data to file(s) ( ).

The following command line parameters are supported:
Data sources to be read (data source 1, data source 2, 3, . . . );
Database to be output;
Deviation of the data sources;
Desired resolution;
Desired elevation type (maximum/average);
Version information (version number);
Area.

These parameters, which are set in the process description file, are checked once again by each of the individual tools.

The following come into consideration as additional parameters:
Horizontal reference system (e.g., WGS84)
Vertical reference system (e.g., mean sea level, MSL).

This allows the use of other horizontal or vertical reference systems.

Conditions that have to be met before the data processing is carried out are called preconditions. They thus pertain to the data that is to be read in, and in the present example, they must be met for each individual segment.

The following preconditions are used in the present example:
PRE1 Either both elevation data and deviation value segments must exist, or else neither of the two.
PRE2 The horizontal reference system must be WGS84.
PRE3 The vertical reference system must be mean sea level (MSL).
PRE4 The resolution must correspond to the desired resolution.
PRE5 The elevation indication type must correspond to the desired type.

Each of these five preconditions being used in the present example are checked in part by the particular tools involved before the processing of the imported data.

In the same way, the processed data are checked, in that they must meet certain conditions. These conditions can depend on the processed data, or can include a comparison of the output data and the processed data. As a result, all of the conditions for the processed data (postconditions) are shown below, whereby each tool checks a subset of these conditions.
SEG_EXS [sic] If an input segment exists, an output segment must also exist.
ELV_EQU The elevation indication of the output data corresponds to the elevation indication of the data that were input (the elevation indications were not changed).
ELV_GRE The output elevation indications are greater than or equal to the imported elevation indications.
DEV_EQU The output deviation values are equal to the deviation values that are output, i.e., the deviation values are unchanged.
DEV_GRE The output deviation values are greater than or equal to the imported deviation values.
TYP_EQU The type of the post (terrain, sea water, body of water, NO_DATA) is unchanged.

In the following, the individual steps (import through export) that run under the control of the process description file will now be explained in greater detail.

Import Tool (s1_import)

Using this tool and in this step (s1_import), the data in the particular existing data format are imported for each individual data source, e.g., Gtop30, Globe1.0, etc., and are stored in a uniform format. Due to the different formats for the different data sources, there is a special import tool for each individual data source, although only a single import tool is shown in FIG. 5.

In addition, a deviation is created by the import tool for all of the imported data and is stored in the form of a deviation file. The deviations that have been stored in this way are in accordance with the accuracy of the corresponding data source.

Overall, it can be seen from FIG. 5 that, first, the s1_import tool receives as input data the data from data sources DEM, and second, it also creates s1_import data files for the elevation data and the deviation data represented in the appropriate format. In addition, a s1_import.log log file is created, in which the s1_import step is fully documented.

The s1_import tool contains parameters from the process tool ais Process. These parameters are first, the deviation values and second, the type of elevation data that is to be imported. For example, it can be specified here whether files that contain average elevation indications are to be imported, or if files that contain the maximum elevation indications are to be imported.

No conditions are checked by the import tool for the imported files.

The present example is currently able to import and evaluate the following five data sources:

Gtopo30, Etopo30, Globe1.0, Globe0.5, and various other topography files for airports or other areas for which high accuracy is desired.

The different sources are imported by the following tools:

s1_importGtopo30, s1_importEtopo30, s1_importGlobe10, s1_importGlobe0.5 and s1_importAirports.

The Gtopo30 file makes available data with a 30 angle seconds resolution in blocks that are usually 90°×40°. In that regard, each elevation is represented by a 2-byte integer in LSB (least significant bit) format. In this file there are no areas without elevation data. Seawater is represented by the value −9999. In the present example, each value for seawater is transferred in the import step to the value −20,000, which in the present example represents seawater of elevation 0.

The data source Etopo30 contains data from all of the continents, each in the form of a large matrix. Each elevation is represented as a 2-byte integer in big-endian format. The values normally represent elevations in meters, however the values for Africa are given in feet. Accordingly, these values have to be converted from feet to meters by the import tool during importation. Due to deficiencies in the data for Africa, they will be omitted from this example entirely.

The Globe10 data source provides elevation data with 30 angle seconds resolution in blocks that are 50°×40°. These values are 2-byte integers in MSB (most significant bit) format. Here again, there are no regions without elevation data. Seawater is represented by the value −500, so in the present example, the import tool converts this value to −20,000.

The Globe0.5 data source provides data in 1°×1° segments with 30″ resolution. The data exist as 2-byte integers. Seawater is represented by the value 0 and is converted to −20,000.

The data sources for elevation data in the vicinity of airports often exist in the form of a binary matrix. These values are usually imported and then stored directly in the desired format.

Data Conversion Tool (s2-convert)

The data that have been stored by the s1_import tool are taken up again by the s2_convert data conversion tool and, in the present example, are converted to the WGS84 system for the horizontal resolution and to mean sea level (MSL) for the vertical resolution. The data that have been created in this way are then stored by the data conversion tool (s2_convert) and a log file s2_convert.log is created for it. The s2_convert data conversion tool evaluates the following two parameters from the ais Process process tool:

Desired horizontal reference system, in the present example, WGS84 exclusively.

Desired vertical reference system, in the present example, mean sea level (MSL) exclusively.

In addition, the s2_convert data conversion tool checks the following conditions, which must be met for imported data (preconditions), whereby the conditions PRE2 and PRE3 are checked in the present example only.
PRE1: Either elevation data and deviation data exist for a segment, or else neither of the two data.
PRE2: The reference system for the imported data must be WGS84 (this condition can also be omitted in other examples, and other data can be processed as well).
PRE3: The vertical reference system must be MSL (this condition also can be omitted in other examples, and data in another reference system can also be processed).

In the case of the present example, then, only data in the WGS84 and MSL reference system are processed, and the created data likewise exist in the this reference system. The task of this data conversion step here in the present example with elevation and deviation data present is thus only to copy them into output files.

The successful execution of the data conversion step is checked, in that three conditions are checked upon completion in the present example:
ELV_EQU The stored elevations that are output must be equal to the imported elevations.
DEV_EQU The output deviations must be equal to the imported deviations.
TYP_EQU The type of the post (terrain, seawater, body of water, NO_DATA) is unchanged.
   Adjustment Tool (s3_adjust)

With this tool and in this step s3_adjust, the resolution of the files created and stored by the s2_convert tool are converted to a desired horizontal resolution. In the present example, the desired resolutions are usually 30 angle seconds or 15 angle seconds.

As can be seen in FIG. 5, the s3_adjust tool reads the data stored by the s2_convert tool and creates s3_adjust output data again itself, along with a log file s3_adjust.log, by means of which step s3_adjust is fully and verifiably documented.

The following parameters are taken into account by the ais Process tool:

Desired Resolution:

In the present example, the desired resolution can be 30 angle seconds or angle seconds, whereby a segment then contains 120×120 or 240×240 cells (sections or elevation values/deviation values).

Desired Elevation Indication Type:

This parameter is used to indicate whether the elevation values created by the s3_adjust step should be maximum elevation values or average elevation values. Depending on this, a different algorithm will be applied during the processing of the data by the s3_adjust tool.

The imported data are checked segment by segment by the s3_adjust tool for the following conditions:

PRE 1, PRE2 and PRE3 as in the s2_convert tool.

The data that are then imported and checked are processed according to the following steps.

An integer number of data (elevation datum+deviation datum) are always combined within a cell into single data combination that is output, consisting of elevation value and deviation value. FIG. 10A represents the combination when the desired elevation indication in the cell in question is to be a maximum elevation value. A total of four elevation values p₁ through p₄ lie within a rectangular cell area. In connection with this, lighter areas in FIG. 10A denote higher elevation values. From these, the highest elevation value p₃ is now chosen to represent the entire cell.

Shown in FIG. 10B is the choice by means of which the desired average elevation value is determined. Here again, four elevation values p₁ through p₄ lie within a cell for which only one final elevation value is required, whereby lighter regions indicate the higher elevation value. In this case, a weighted average is computed from the values p₁ through p₄ by means of Kalman filtering. The output data value can therefore be described as K (p₁ . . . p₄).

Here, the Kalman filtering is performed as follows:

The values p₁=(e₁, s₁) and p₂=(e₂, s₂), with e₁ and e₂ the elevation values and s₁ and s₂ the deviation values, are combined in that the following Kalman function is applied to them:
K(p₁,p₂, . . . , pₙ)=(k(k( . . . k(p₁,p₂), . . . ),pₙ)
whereby the function k is demonstrated in the following using the two value pairs p₁ and p₂.
[see equation in original document]

In this way, the individual value pairs for the cells are combined in weighted fashion with their given deviations, so that a weighted average value K (p₁ . . . p₄) is created when there are four elevation values within a cell. Here the output deviation is smaller that the input deviations, since it is more probable to compute the “real” average elevation.

A summary of the procedural steps executed in the s3_trust [sic] tool is shown as an algorithm in FIG. 11.

For step s3_adjust, the same postconditions ELV_EQU, DEV_EQU and TYP_EQU are relevant as in s2_convert.

Trust Tool (s4_trust)

This tool performs various additional checks of the data stored by step s3_adjust, and increases the deviation in the given data pair comprised of elevation indication and deviation if there is found to be doubt concerning the elevation indication.

This tool does not process any parameters, but does check the imported data, which now refer to individual cells, for the conditions PRE1 through PRE3 as described above, as well as for condition PRE4, namely, that the horizontal resolution of the imported data must already correspond to the desired resolution.

First, checks are performed by the s4_trust trust tool in order to detect outliers in the elevation values. To do this, each value is checked to see if its elevation value e differs greatly from the elevation values of its neighbors:
¦e−e¦>n·s and ¦e−e¦>50 m
where e is the average of the neighbors of the value to be checked and s is the standard deviation of the neighboring values. The threshold value of the permissible deviation is indicated by n, whereby n=3 is used in tie present example.

Evaluated as the neighboring values are the neighboring values e₁ though e₈ shown in FIG. 12. The elevation value to be checked is represented by e.

If a outlier is found in this way, then the deviation of the corresponding value e is set equal to the maximum of the current deviation value and ¦e−e¦−3 s.

FIG. 13 illustrates this described process step in the form of an algorithm.

The data that have been modified in this way are then checked to see that they meet certain conditions. In step s4_trust, the previously described condition ELV_EQU is checked first, and then condition DEV_GRE, namely, whether each of the deviation values that have been exported and are to be stored is greater than or equal to its corresponding imported deviation value. The previously mentioned TYP_EQU condition is checked as well.

Offset Tool (s5_offset)

In this step, the data created and stored by the trust tool s4_trust are imported again and optionally, maximum elevation values are created from the average elevation values contained in them and are stored. Of course, this is necessary only if the desired elevation indication type is a maximum elevation. If the desired elevation indication type is an average elevation indication, no processing is done in this step.

The offset tool s5_offset imports the desired elevation indication type as a parameter. If a maximum elevation indication is being performed, step s5_offset is executed. If the desired elevation indication type is an average elevation, step s5_offset is not executed.

The s5_offset offset tool checks the imported data for the conditions PRE1 through PRE4 that have been described above, then optionally carries out the following conversion, which is clarified through reference to FIG. 14. In FIG. 14, e denotes a cell's elevation value, which is to be converted from an average elevation value to a maximum elevation value. Indicated by e₁ through e₈ are their neighboring cells, or more specifically, the elevation values contained in them.

This step now checks to see which of the e values, e₁ through e₈, the greatest elevation value, and replaces the value e with the greatest elevation value found in this way. If e is itself the greatest elevation value, then of course no replacement is made.

Deviation value d is not changed.

Optionally, it is also possible to provide e with an added value for safety (safety offset) in the event that e itself is the greatest elevation value. To do this, the difference between the value e and the average of its neighbors e1 through e8 is added to the value e. A maximum of reliability and safety is achieved for the value e through such an offset.

FIG. 15 explains the s5_offset tool procedure described above once again in the form of an algorithm. The logic operator > is defined as follows with reference to the elevation indications e:

$${e}_{1} > {e}_{8} = \begin{matrix}( true if {e}_{1} ? NO DATA PRESENT and {e}_{1} higher than {e}_{2} \\ ( -- -- -- -- -- -- -- -- -- -- -- -- -- -- -- -- -- \\ ( false else\end{matrix}$$

The data created in this way are checked once again for the conditions ELV_GRE, DEV_EQU and TYP_EQU as already described above.

Merging Tool (s6_merge)

While all of the previous steps s1 through s5 were executed individually for each individual data source, now all of the data obtained from the individual data sources and processed according to the previous steps are merged for the first time.

This is shown in FIG. 16A. Step s6_merge, or the associated tool, imports all of the data created from the individual data sources by the s5_offset tool, and creates from it a common s6_merge database along with a log file to document the s6_merge step.

To do this, step s6_merge is also controlled by parameters that are predetermined by the process tool ais Process. In the present example, the type of elevation indication that is to be created is used as the parameter. This type can be either a maximum value or an average value taken from all of the values for the cell in question from the individual databases that were imported.

As the condition for the values imported from the individual databases, conditions PRE1 through PRE5 as described above are checked.

To determine an average elevation value from all of the individual elevation values of the data sources for a specific cell, Kalman filtering as described above is performed again.

Additional, special problems arise in this step, however. For example, for individual cells in the individual databases, either an elevation value can exist, or a value stating that only seawater is present, a value indicating that a body of water is present, or there may be no data for a specific cell or for the cells of a certain segment (ND, No Data).

In that case, certain logic operations are required that are explained in FIGS. 16B and 16C.

FIG. 16B shows the logical combining of two values, whereby these values can either be missing (No Data, ND), can represent elevation values (T) or can represent water values (W). As can be seen in FIG. 16B, in the event that the two values are missing, the lack of an average value is determined. If only one value is missing and the other value is an elevation value T or a water value W, the elevation value T or the water value W is used as the average value. In the event that an elevation value T and a water value W exist, then only the elevation value T is taken as the average value. In the event that two elevation values T exist, the previously described Kalman filtering is performed and the new elevation value T corresponds to the Kalman function from the individual elevation values (T). The same applies in the event that only two water values are present.

FIG. 16C shows when two values that are to be combined either have no data (ND), have elevation values (T), indicate seawater (SW) or indicate surface water (BW).

In this case as well, the logic operation is performed with priority given to the elevation values above all other values. If two value types exist, Kalman filtering is performed.

FIG. 16C differs from FIG. 16B in that a distinction is made between two water values of differing importance, namely, seawater (SW) and other bodies of water (BW) such as lakes or rivers. The combining operations from FIG. 16B are included in their entirety in FIG. 16C, so that new combining operations result only for the additional values for bodies of water: In the event one of the values is missing, the body of water value BW is taken as the average value. The combining of an elevation value T and a body of water value BW takes place in that the elevation of the body of water per Kalman filtering is fused with the elevation value T, and the result is converted back into a body of water value. In the combining of a body of water value BW with a seawater value SW, the body of water value prevails and is used as the average value. The combining of two body of water values BW takes place through conventional fusion by means of Kalman filtering.

If more than two data sources are combined with each other, the given combining operations can always be performed between two data sources, and the result then combined with an additional data source. Because of the associative and commutative properties of Kalman filtering, as well as the other logical combining operations according to FIGS. 16B and 16C, any other desired sequence of combining operations of individual data sources can also be performed.

FIG. 17 shows an excerpt from an algorithm that describes the method of the s6_merge tool as described above.

The output data are checked for the following postconditions:
SEG_EXS If an input segment exists, an output segment must also exist.
ELV_GRE* The output elevation is greater than or equal to the lowest input elevation.
   Export Tool (s7_export)

The export tool can be used optionally in order to put the representation of the earth's surface produced in this way into a format that meets customer requests, for example. The elevation indications in this representation are no longer changed by the export tool in terms of content.

The values stored by the s6_merge tool are imported by the export tool s7_export and checked for conditions PRE1 through PRE5 as described above. Subsequently, a conversion to the desired format takes place and the data are then stored. An example of the steps executed by the s7_export tool is shown in FIG. 18.

The export tool s7_export then writes the data into a predefined directory structure.

Finally, the data that have been written are checked for condition ELV_EQU as described above.

This completes all of the processing steps of the production process for the representation of the earth according to the invention.

FIG. 19 shows the directory structure for the entire process to be executed. A directory called Process Directory is used as the main directory for storing all of the data. In each of the individual steps s1_import through s7_export, a subdirectory is created with the corresponding names s1_import through s7_export. Since each of the steps s1_import through s5_offset individually processes a single data source, e.g., Etopo30, Airports, etc., within the given directory s1_import through s5_offset a subdirectory with corresponding name is created for each of these data sources. Directories W180 through E179 that store the given segment files are created within the lowest directory level so created.

Directories W180 through E179 contain all of the elevation value and additional-value files for the degree of longitude defined by the names of the directories (W180 means 180 degrees west longitude, for example). The s6_merge directory directly contains the subdirectories W180 through E179, since the data from various sources have been combined into one data record after this step. Directory s7_export<Customer> contains the same data as s6_merge, but converted into a customer-dependent format. The appended <Customer> is then replaced by the actual customer name.

In the following, the structure and the contents of a representation (customer-specific format) created according to the method described above are shown by way of example.

FIG. 20 shows the directory structure of an exemplary representation. This representation or database can be recorded on any desired medium and can also be transmitted on any desired medium. In the present example, a compact disc is used for this purpose. However, the present invention pertains to a representation in any stored form whatsoever on any possible medium whatsoever.

FIG. 20 shows the directory structure of this exemplary representation. It has a Read-me file in which interesting information regarding the representation is stored in cleartext, and a VERSION file containing the exact identification of the representation. The actual data are found in a main directory AIS-XXX, where XXX designates the version. This main directory has two subdirectories, DIR and DOC. The DIR directory is the directory containing the data. Found first in the DIR directory are the process description file <process_description>.xml, the log files for the ais Process processes, s1_import through s7_export for all of the data sources, and the given results of the processes, as well as three information files DIR_<res><type>.ter, DIR_<res><type>.sea and DIR_<res>_<type>.nod, in which information is stored regarding whether elevation data (.ter), sea data (.sea), or no data at all (.nod) are available for the individual segments. These files are ASCII files, each of which indicates whether specific data is available for a segment with a longitude of one degree and a latitude of one degree. These cover the entire world, and contain a total of 180 lines with 360 entries. The first line represents 90° north latitude, while the first column represents 180° west longitude.

The entry for each segment is a 1 or a 0. In *.ter files, a 1 indicates that the segment in question contains elevation data. In *.sea files, 1 indicates that such a segment file does not exist, since all of the data would only indicate mean sea level. In *.nod files, a 1 indicates the lack of the segment file in question, since no data are available for this segment.

A consistency check can be carried out for the content of these three files *.ter, *.sea and *.nod, since the sum of the entries for the individual segments must always be exactly 1.

If mixed data are present, e.g., partly elevation data and partly no data for a segment, an entry in the *.ter file takes place, while in the event that neither sea data are present nor another kind of data as a special case, the entry of a 1 in the *.ter file takes place, and then the segment file with the corresponding offset values for the individual sections is entered as well. FIG. 23 shows an excerpt from such a *.ter file, which can additionally be preceded by any desired number of commentary lines.

The DIR directory contains a total of 2592 directories, each of which corresponds to an area of 5°×5° and is designated by xxxhyyk. Such a directory is shown in FIG. 20. The degrees of longitude of the northwest corner of the area represented is designated by xxx, h designates east or west longitude, yy designates the latitude of the northwest corner of the area represented, and k designates north or south latitude.

Each of these directories contains a total of three files with the endings sea, .tgz and .md5. File xxxhyyk.sea contains a list of segments that are not made available as files, since they contain only sea values. File xxxhyyk.md5 contains a CRC checksum of files xxxhyyk.tgz and xxxhyyk.sea per the MD5 checksum convention.

File xxxhyyk.tgz is a compressed file that in turn contains directories elv and qty. Found in the elv directory are all of the *.elv files that contain the elevation data of the individual segments. These files are designated with a filename xxxhyyk.elv, whereby the naming is applied as above and c stands for “standard segment”.

The qty directory contains corresponding files xxxhyykc.qyt with the reliability or accuracy values for the sections of the individual segments.

For example, 011e48ns.elv designates the segment with its northwest corner at 11° east longitude and 48° north latitude in Austria. This file contains the data for the standard segment, and contains elevation data.

FIGS. 21 and 22 show the structure of the segment files. FIG. 21 shows that a number of files have been created for a certain segment of the earth's surface, each of which contains different types of data. For example, an elevation data file is attached, as is a quality data file. This has also been described above. Optionally, files with standard deviation values can also be recorded, as can other files. The present invention is not limited to two different values per section, here elevation data and reliability or accuracy data.

Storage within one of these files for the values within a segment takes place in that the values of the first row are recorded first, followed by the rest of the rows in order.

In the present example, two files exist for each segment, namely, one file with elevation indications and one file with reliability or accuracy indications for each individual section or cell.

Each of these files contains the following blocks:
General header information
File-specific header information
File-specific data records.

All of these files are binary data files. The byte order is according to the Motorola byte order, in which the most significant byte is recorded first (most significant byte, msb). FIG. 24 shows the general header area that is present in all types of segment files (elevation data and reliability or accuracy data). With the exception of the case type identifier, this general header area is identical for all files of one segment. Its total length is 116 bytes.

FIG. 25A and FIG. 25B show the data-specific header area (FIG. 25A) and the data area (FIG. 25B) for a file with elevation data.

FIG. 26 shows in subfigures A through C the file-specific header area (FIG. 26A), the area for the designation of the reliability definition (FIG. 26B), and the data area for recording the reliability data (FIG. 26C).

In the present example, a total of seven different definitions of reliability or accuracy are available, so that each of the representations according to the invention can have a desired value for accuracy and/or reliability for every elevation datum.

FIG. 27 defines in more detail in subfigures A through AM the parameters contained in the header areas.

In FIG. 27, the following subfigures designate the following parameters:
A file type
B byte order
C byte order check value
D version code
E creation data
F segment name
G horizontal reference value
H vertical reference value
I longitude of a segment corner
K latitude of a segment corner
L longitudinal extent of a segment
M latitudinal extent of a segment
N resolution in terms of geographic longitude
O resolution in terms of geographic latitude
P longitude of the first value
Q latitude of the first value
R number of columns
S number of rows
T content identifier
U metric scale
V type of elevation data
W number of bytes per data value
X minimum data value in a segment
Y maximum data value within a segment
Z value of the identifier for missing data values
AA number of records
AB minimum data value of the current records
AC maximum data value of the current records
AD longitude of the first value within the current record
AE longitude of the first value within the current record [sic]
AF elevation value
AG number of accuracy and/or reliability definitions used in the present representation
AH accuracy/reliability identifier
AI absolute horizontal accuracy
AK relative horizontal accuracy
AL absolute vertical accuracy
AM relative vertical accuracy.

1. Representation of at least one area of the earth's surface wherein the area is subdivided into individual sections, and two data values are given for each individual section, whereby a first one of the data values contains an elevation indication of the surface above a predetermined level, and a second one of the data values gives a measure of at least one of the accuracy and reliability of the first data value.

2. A representation according to claim 1 wherein the first and second data values are first and second digital data values.

3. A representation according to claim 1 wherein the earth's surface is divided into individual sections by a system of grid lines.

4. A representation according to claim 3 wherein the system of grid lines relates to the WGS-84 ellipsoid.

5. A representation according to claim 2 wherein each section corresponds to an area encompassed by two degrees of latitude and two degrees of longitude.

6. A representation according to claim 3 wherein at least one of said sections encompasses an area of 30 arc-seconds×30 arc-seconds.

7. A representation according to claim 3 wherein at least one of said sections encompasses an area of 15 arc-seconds×15 arc-seconds.

8. A representation according to claim 1 wherein at least one of the first data and the second data provides an indication regarding the geographic center of the section.

9. A representation according to claim 1 wherein the elevation indication of at least one of the sections relates to mean sea level.

10. A representation according to claim 1 wherein the elevation indication of at least one of the sections indicates one of a maximum terrain elevation within the section and a minimum terrain elevation within the at least one section.

11. A representation according to claim 1 wherein the elevation indication of at least one of the sections indicates an average terrain elevation within the at least one section.

12. A representation according to claim 1 wherein the elevation indication of at least one of the sections indicates a weighted average terrain elevation within the at least one section.

13. A representation according to claim 1 wherein the elevation indications are defined in meters.

14. A representation according to claim 1 wherein the elevation indications of a section are modified by a predetermined value in order to contain an indication of the type of terrain in the section.

15. A representation according to claim 14 the first data value of a section contains one of the value −20000 and the elevation indication minus 20000 if the terrain of the section is one of a sea and an unknown type of body of water.

16. A representation according to claim 1 wherein the first data value contains the elevation indication minus 30000 if the terrain of the section is one of a sea and a river.

17. A representation according to claim 1 wherein the first data value contains a predetermined value if no elevation indication can be determined for a section.

18. A representation according to claim 17 wherein the predetermined value is −9999.

19. A representation according to claim 1 wherein for at least one section the second data value contains an indication of at least one of the horizontal deviation, horizontal quality, horizontal reliability, horizontal confidence level, vertical deviation, vertical quality vertical reliability and vertical confidence level of the elevation indication of a section.

20. A representation according to claim 1 wherein for at least one section the second data value indicates at least one of the reliability of at least one of the elevation indications and confidence level of at least one of the elevation indications.

21. A representation according to claim 20 wherein the reliability is determined from at least one of the horizontal relative deviation of the elevation data of a section, the horizontal absolute deviation of the elevation data of a section, the vertical relative deviation of the elevation data of a section and the vertical absolute deviation of the elevation data of a section.

22. A representation according to claim 1 wherein the first data value and the second data value are stored in different files.

23. A representation according to claim 1 wherein the area of the earth's surface is divided into a number of segments, each segment containing several sections, and
the first data values of the sections and the second data values of the sections, which collectively represent a segment of the earth's surface, are stored in one of the following two ways: one segment file each and, together in a segment files file.

24. A representation according to claim 23 wherein the first data value and the second data value are each stored in their own segment files.

25. A representation according to claim 23 wherein at least one segment is bounded by two adjacent degrees of longitude and two adjacent degrees of latitude.

26. A representation according to claim 25 wherein said at least one segment is bounded by two adjacent degrees of longitude and two adjacent degrees of latitude of the WGS-84 ellipsoid.

27. A representation according to claim 24 wherein at least several segments are bounded from one another by degrees of latitude and degrees of longitude in the same degree interval.

28. A representation according to claim 23 wherein at least one segment file contains the data of a section of an area of the earth's surface 1°×1° in size.

29. A representation according to claim 23 wherein at least one of the first and second data values of the sections of a segment, each beginning with a northwest section, are stored in sequence one after the other in their progression on a circle of latitude in an easterly direction, and sequential rows adjoining one another are stored one after the other in a southerly direction.

30. A representation according to claim 23 wherein at least one segment file exhibits at least one of a first header area in which are contained information concerning at least one of the position, extent and size of the segment, and a second header area in which are contained information concerning at least one of the program used for producing the segment file, the production date, the type of the elevation indication the maximum elevations occurring in the segment, the minimum elevations occurring in the segment, and information regarding the type of the second data value.

31. A representation according to claim 1 including at least one file that indicates whether a segment file with elevation data exists for each segment.

32. A representation according to claim 1 including at least one file that indicates whether no segment file exists for each segment.

33. A representation according to claim 1 including at least one file that indicates whether no segment file exists for each segment.

34. A representation according to claim 1 including at least one of the following:
at least one file that indicates whether a segment file with elevation data exists for each segment, and
at least one file that indicates whether no segment file exists for each segment.

35. A method for creating a representation according to claim 1 including
a) for each at least one data source containing at least one of a first data value, an accuracy indication and a reliability indication for the first data value contained in the data source for at least one part of the area to be represented, at least one of the following steps a1)-c) is executed:
a1) importation of the data from the data source and conversion of the first data value into a predetermined data format, and for each individual first data value, generation of a second data value that represents at least one of the deviation of the first data value from the actual elevation and an error value regarding the first data value,
a2) translation of at least one of the converted first data value and the second data value into a predetermined standard with regard to at least one of the horizontal plane and the vertical direction,
a3) conversion of the converted and translated first data value and second data value to a predetermined horizontal resolution,
a4) check of the first data, values for credibility, and computation and assignment of a second data value for each first data value as a measure for at least one of the accuracy and reliability of the first data value,
a5) to the extent that the first data values represent average values for an area or a section, determination of a maximum elevation from the average values;
b) at least one of: for each first data value, a new first data value is created; and, for each second data value a new second data value is created; and
c) the at least one of the created, new first data value and new second data value is converted into a predetermined data format.

36. A method according to claim 35 wherein the new second data values are created from the second data values from all data sources by Kalman filtering.

37. A method according to one claim 35 wherein at least one of the data sources that are to be used, the area of the earth's surface for which the representation is to be created, the steps that are to be executed and the predetermined parameters are determined and are stored in a process control file.

38. A method according to claim 37 wherein predetermined parameters of all of the steps that are to be executed and the steps that are to be executed are stored in a collective process control file.

39. A method according to claim 37 wherein the process control file contains the predetermined horizontal resolution as well as the type of the elevation data of the representation that is to be created.

40. A method according to claim 35 wherein after each step, the data created by that step are stored.

41. A method according to claim 35 wherein the subsequent step processes the data created and stored by the preceding step.

42. A method according to claim 35 wherein in each step, the predetermined parameters that are used in that step are checked, the at least one of the first data value and the second data value created by the preceding step or present in the data sources is imported, processed, and the processed one of the first data value and the second data value is stored.

43. A method according to claim 35 wherein, for each step, a log is stored of the data processing that took place.

44. A method according to claim 35 wherein the data exhibits one of the following: no or one equal indication concerning the accuracy of the first data value for all of the first data values contained therein.

45. A method according to claim 35 at least one of before and after at least one processing step, at least one of the integrity of the data, the reliability of the data and the proper execution of the step is checked.

46. A method according to claim 45 wherein, for predetermined processing steps, at least one of the integrity of the data, the reliability of the data and the proper execution of the step is checked.

47. A method according to claim 35 wherein, after at least one of step b) and the last step if the last step is not step b), at least one of the integrity of the data, the reliability of the data and the proper execution of the steps are is checked.

48. A method according to claim 45 wherein the results of the check are recorded in a log.

49. A method according to claim 35 wherein, if step a2) is performed, then in step a2), the data in the horizontal direction are translated to the WGS-84 system and the data in the vertical direction are translated to mean sea level.

50. A method according to claim 35 wherein, if step a3) is performed, then in step a3), the data are converted to one of: a horizontal resolution of a section of an integer multiple of 1 arcsecond: and, an extent of a section of an integer multiple of 1 arcsecond.

51. A method according to claim 50 wherein, if step a3) is performed, then in step a3), the data are converted to one of: a horizontal resolution of a section of one of 30 arc-seconds and 15 arc-seconds; and, an extent of a section of one of 30 arc-seconds and 15 arc-seconds.

52. A method according to claim 35 wherein, if step a4) is performed, then in step a4), the accuracy of the first data value is checked individually for each section and each data source to provide a result, and the second data value is modified in dependency on this result.

53. A method according to claim 35 wherein, if step a5) is performed, then in step a5), a maximum elevation is determined from the average elevation indications.

54. A method according to claim 35 wherein a heuristic value is added to the average elevation indication.

55. A method for air traffic control of an aircraft, wherein
during a flight of an aircraft, at least one of the current elevation, position and air route of the aircraft is determined, the first data value and the second data value of the representation according to claim 1 are determined for at least one of the aircraft position and the air route, and the thus-determined first data value and second data value are compared with at least one of the current elevation and the air route of the aircraft.

56. A device for safeguarding an aircraft against contact with the ground, including a device for storing a representation according to claim 1, a device for determining at least one of the elevation, the position and the air route of the aircraft, a device for exporting at least one of: individual sections of the representation; and, several sections of the representation, whereby those sections of the representation that represent the earth's surface at the at least one of the ascertained position and on the ascertained air route of the aircraft are exported and are compared with the actual elevation and air route of the aircraft.
